(19) United States
(12) Patent Application Publication
(10) Pub. No.: US 2023/0191911 A1
(43) Pub. Date: Jun. 22, 2023

(54) VEHICLE DISPLAY APPARATUS

(71) Applicant: DENSO CORPORATION, Kariya-City (JP)

(72) Inventors: Kazuki IZUMI, Kariya-City (JP); Takuya KUME, Kariya-City (JP); Takahisa FUJINO, Kariya-City (JP); Toshiharu SHIRATSUCHI, Kariya-City (JP); Shuntaro FUKUI, Kariya-City (JP); Shiori MANEYAMA, Kariya-City (JP); Kaneyasu KOIDE, Kariya-City (JP)

(21) Appl. No.: 18/165,297

(22) Filed: Feb. 6, 2023

Related U.S. Application Data
(63) Continuation of application No. PCT/JP21/29254, filed on Aug. 6, 2021.

(30) Foreign Application Priority Data
Aug. 27, 2020 (JP) 2020-143764
Feb. 25, 2021 (JP) 2021-028873
Apr. 16, 2021 (JP) 2021-069887

(51) Int. Cl. B60K 35/00

(52) U.S. Cl. CPC B60K 35/00; B60K 2370/175; B60K 2370/176; B60K 2370/152; B60K 2370/179; B60K 2370/1876; B60K 2370/52

(57) ABSTRACT

A vehicle display apparatus includes: a meter display which displays a vehicle traveling information; a locator, a surrounding monitoring sensor, and an in-vehicle communication device which acquire vehicle position information and vehicle surrounding information; and a HCU. The HCU displays, based on the vehicle position information and the vehicle surrounding information, a front area image including the vehicle on the meter display when an autonomous driving function is not demonstrated, and displays the front area image and a rear area image including a following vehicle in a continuous and additional manner on the meter display when the autonomous driving function is demonstrated.

### CROSS REFERENCE TO RELATED APPLICATIONS

The present application is a continuation application of International Patent Application No. PCT/JP2021/029254 filed on Aug. 6, 2021, which designated the U.S. and is based on and claims the benefit of priority of Patent Application No. 2020-143764 filed in Japan on Aug. 27, 2020, Patent Application No. 2021-028873 filed in Japan on Feb. 25, 2021, and Patent Application No. 2021-069887 filed in Japan on Apr. 16, 2021, the whole contents of the applications are incorporated by reference in their entirety.

### TECHNICAL FIELD

This disclosure relates to a vehicle display apparatus for a vehicle having an autonomous driving function.

### BACKGROUND

A vehicle display apparatus is required to display a surrounding information such as positional information about a preceding vehicle and/or a following vehicle. In addition, vehicles having an autonomous driving function creates new surrounding information and some special situations which should be recognized by a driver. For example, a handover transferring vehicle operations in both directions between a manual driving and an autonomous driving creates new situation. In the above aspects, or in other aspects not mentioned, there is a need for further improvements in a vehicle display apparatus.

### SUMMARY

According to a first disclosure, a vehicle display apparatus, comprising: a display unit which displays traveling information of a vehicle; an acquisition unit which acquires position information of the vehicle and surrounding information of the vehicle; and a display control unit which, based on the position information and the surrounding information, displays a front area image including the vehicle on the display unit when an autonomous driving function of the vehicle is not demonstrated, and displays the front area image and a rear area image including a following vehicle in a continuous and additional manner when the autonomous driving function is demonstrated.

According to the first disclosure, even if it is performing the autonomous driving in which the obligation to monitor the surrounding is unnecessary, since the rear area image including the vehicle and the following vehicle is displayed on the display unit, it is possible to recognize the relationship of the subject vehicle and the following vehicle.

According to a second disclosure, a vehicle display apparatus, comprising: a display unit which displays traveling information of a vehicle; an acquisition unit which acquires position information, a traveling state, and surrounding information of the vehicle; and a display control unit which displays a surrounding image of the vehicle on the display unit as one of the traveling information, and switches a display form relating to a relationship among the vehicle and the surrounding vehicle in the surrounding image according to: a level of the autonomous driving of the vehicle set based on the position information, the traveling state, and the surrounding information; the traveling state; and a state of surrounding vehicles as the surrounding information.

According to the second disclosure, since the display form relating to the relationship among the vehicle and the surrounding vehicles is displayed in a switching manner in accordance with the autonomous driving level of the vehicle, the traveling state, and the situation of the surrounding vehicles, it is possible to appropriately recognize the relationship among the vehicle and the surrounding vehicles.

### BRIEF DESCRIPTION OF DRAWINGS

The disclosure is further described with reference to the accompanying drawings in which:

FIG. 1 is a block diagram showing an overall configuration of a vehicle display apparatus;

FIG. 2 is an explanatory diagram, in the case that a distance from a following vehicle is small, showing a changing to a display of a front area image including a subject vehicle and an additional rear area image, if there is a following vehicle;

FIG. 3 is an explanatory diagram showing a display form in the case that a distance between the subject vehicle and the following vehicle is less than a predetermined distance;

FIG. 4 is an explanatory diagram showing a display form in the case that a distance between the subject vehicle and the following vehicle is equal to or larger than a predetermined distance;

FIG. 5 is an explanatory diagram showing a case where a distance between the subject vehicle and the following vehicle varies;

FIG. 6 is an explanatory diagram showing a case where an area of the rear area is fixed;

FIG. 7 is an explanatory diagram showing a case where an area of the rear area is changed in the case that a variation in the distance between the subject vehicle and the following vehicle becomes small in FIG. 6;

FIG. 8 is a flow chart showing a control procedure for changing the display form according to a situation of the following vehicle;

FIG. 9 is an explanatory diagram showing a display form, i.e., an emergency vehicle and a message, in the case that there is an emergency vehicle in the rear area;

FIG. 10 is an explanatory diagram showing a display form, i.e., a simple display and a message, in the case that there is an emergency vehicle in the rear area;

FIG. 11 is an explanatory diagram showing a display form, i.e., a simple display only, in the case that there is an emergency vehicle in the rear area;

FIG. 12 is an explanatory diagram showing a unity image display, i.e., a color display on a road surface, in the case that the following vehicle follows by using an automatic following driving;

FIG. 13 is an explanatory diagram showing a unity image display, i.e., the same vehicle display, in the case that the following vehicle follows by using an automatic following driving;

FIG. 14 is an explanatory diagram showing a unity image display, i.e., a towing image, in the case that the following vehicle follows by using an automatic following driving;

FIG. 15 is an explanatory diagram showing a display form 1 in the case that a following vehicle may be road rage;

FIG. 16 is an explanatory diagram showing a display form 2 in the case that a following vehicle may be road rage;

FIG. 17 is an explanatory diagram showing a display form in the case that the autonomous driving is switched from level 2 to level 3;

FIG. 18 is an explanatory diagram showing a difference in timing at which the display form of the surrounding image is switched;

FIG. 19 is an explanatory diagram showing a display form in the case that the autonomous driving is switched from level 0 to level 3;

FIG. 20 is an explanatory diagram showing a display form in the case that the autonomous driving is switched from level 1 to level 3;

FIG. 21 is an explanatory diagram showing switching between a bird's-eye view display and a two-dimensional display;

FIG. 22 is an explanatory diagram showing a display form in the case that traffic congestion has not been resolved even after switching from traffic congestion limited level 3 to level 2;

FIG. 23 is an explanatory diagram showing a display form in the case that traffic congestion has not been resolved even after switching from traffic congestion limited level 3 to level 1;

FIG. 24 is an explanatory diagram showing a display form in the case that traffic congestion has not been resolved even after switching from traffic congestion limited level 3 to level 0;

FIG. 25 is an explanatory diagram showing a display form in the case that it is switched from area limited level 3 to levels 2, 1, and 0;

FIG. 26 is an explanatory diagram showing that a dangerous vehicle is displayed on both a meter display and an electronic mirror display in an emphasized manner;

FIG. 27 is an explanatory diagram showing a display form in the case that the adjacent lane is congested and is not congested;

FIG. 28 is an explanatory diagram showing a display form in the case that there is no following vehicle at a merging point at traffic congestion limited level 3;

FIG. 29 is an explanatory diagram showing a display form in the case that there is a following vehicle at a merging point at traffic congestion limited level 3;

FIG. 30 is an explanatory diagram showing a display form in the case that there is no following vehicle at a merging point at area limited level 3;

FIG. 31 is an explanatory diagram showing a display form in the case that there is a following vehicle at a merging point at area limited level 3;

FIG. 32 is an explanatory diagram showing a display form in the case that a handover failure;

FIG. 33 is an explanatory diagram showing that following vehicles are hidden after transition to traffic congestion limited level 3 is possible;

FIG. 34 is an explanatory diagram showing that following vehicles are hidden after transition to traffic congestion limited level 3;

FIG. 35 is an explanatory diagram showing a state in which the first and second contents are displayed after transitioning to traffic congestion limited level 3;

FIG. 36 is an explanatory diagram showing third content displayed in the case that the following vehicle is not detected or is absent;

FIG. 37 is an explanatory diagram showing a notification mark; and

FIG. 38 is an explanatory diagram showing a pre-transition image.

### DETAILED DESCRIPTION

A vehicle display apparatus is known as one disclosed in JP6425597B. The vehicle display apparatus, i.e., a driving support system, of JP6425597B is installed in a vehicle having an autonomous driving function, and is configured to display a surrounding situation presenting image which shows a positional relationship among a subject vehicle and other vehicles around the subject vehicle at a handover timing from an autonomous driving to a manual driving. As a result, a driver can quickly recognize a traffic situation around the subject vehicle at a handover timing from an autonomous driving to a manual driving.

However, in situations including not only at a handover timing from an autonomous driving to a manual driving, but also at during an autonomous driving, which requires no obligation to monitor the surrounding, it is desired to provide information including a relationship between the subject vehicle and a following vehicle according to a certain driving situation, such as a situation in which a following vehicle approaches by an automatic following driving control or a situation in which a following vehicle approaches road rage or the like.

In view of the above problem, it is an object of this disclosure to provide a vehicle display apparatus capable of presenting following vehicle information during autonomous driving in relation to a subject vehicle.

Hereinafter, embodiments for implementing the present disclosure is described referring to drawings. In each embodiment, portions corresponding to the elements described in the preceding embodiments are denoted by the same reference numerals, and redundant explanation thereof may be omitted. When only a part of a configuration is described in an embodiment, the other preceding embodiments can be applied to the other parts of the configuration. It may be possible not only to combine parts the combination of which is explicitly described in an embodiment, but also to combine parts of respective embodiments the combination of which is not explicitly described if any obstacle does not especially occur in combining the parts of the respective embodiments.

### First Embodiment

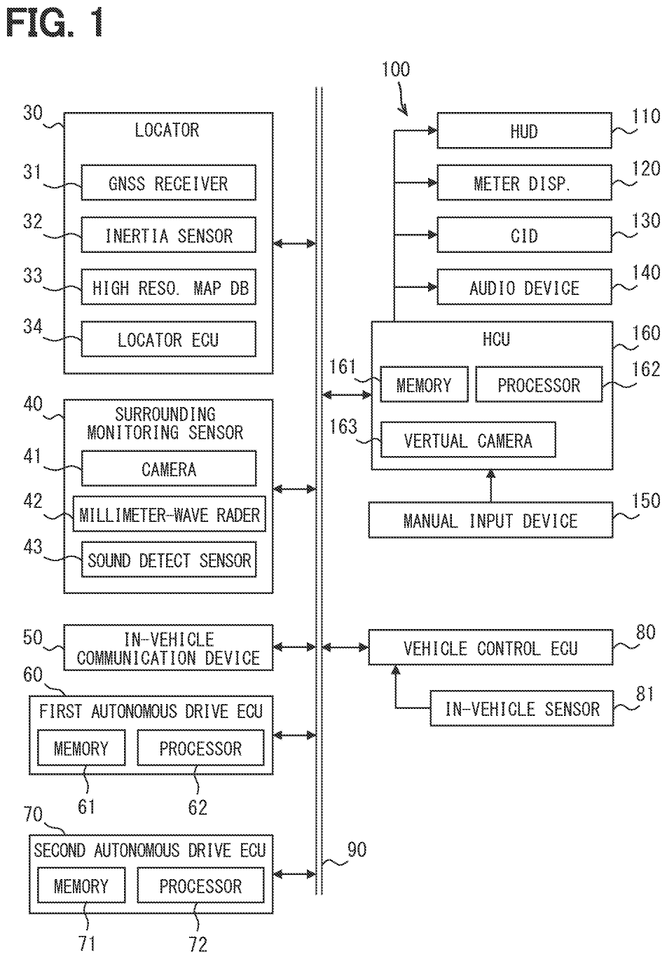

A vehicle display apparatus 100 according to a first embodiment is described with reference to FIGS. 1 to 4. The vehicle display apparatus 100 according to the first embodiment is mounted on, i.e., applied to, a vehicle, hereinafter a subject vehicle 10, having an autonomous driving function. Hereinafter, the vehicle display apparatus 100 is referred to as a display apparatus 100.

The display apparatus 100 includes a HCU (human machine interface control unit) 160, as shown in FIG. 1. The display apparatus 100 displays, on display units (multiple display devices described later), vehicle traveling information such as, for example, a vehicle speed, an engine speed, a shift position of a transmission, and, navigation information by a navigation system, i.e., here, locator 30. In addition, the display apparatus 100 displays an image of the subject vehicle 10 and the surrounding of the subject vehicle 10 on the display unit.

The display apparatus 100 is connected to the locator 30 mounted on the subject vehicle 10, a surrounding monitoring sensor 40, an in-vehicle communication device 50, a first autonomous driving ECU 60, a second autonomous driving ECU 70, and a vehicle control ECU 80 via a communication bus 90 or the like.

The locator 30 forms the navigation system, and generates subject vehicle position information and the like by complex positioning that combines multiple acquired information. The locator 30 includes a GNSS (Global Navigation Satellite System) receiver 31, an inertial sensor 32, and a map database (hereinafter, map DB) 33, and a locator ECU 34 and the like. The locator 30 corresponds to an acquisition unit of this disclosure.

The GNSS receiver 31 receives positioning signals from multiple positioning satellites.

The inertial sensor 32 is a sensor that detects the inertial force acting on the subject vehicle 10. The inertial sensor 32 includes a gyro sensor and an acceleration sensor, for example.

The map DB 33 is a nonvolatile memory, and stores map data such as link data, node data, road shape, structures and the like. The map data may include a three-dimensional map including point groups of feature points of road shapes and buildings. The three-dimensional map may be generated by REM (Road Experience Management) based on captured images. Further, the map data may include traffic regulation information, road construction information, meteorological information, signal information and the like. The map data stored in the map DB 33 updates regularly or at any time based on the latest information received by the in-vehicle communication device 50 described later.

The locator ECU 34 mainly includes a microcomputer equipped with a processor, a memory, an input/output interface, and a bus connecting these elements. The locator ECU 34 combines the positioning signals received by the GNSS receiver 31, the measurement results of the inertial sensor 32, and the map data of the map DB 33 to sequentially detect the vehicle position (hereinafter, subject vehicle position) and a traveling speed (traveling state) of the subject vehicle 10.

The subject vehicle position may consist of, for example, coordinates of latitude and longitude. It should be noted that the position of the subject vehicle may be determined using a traveling distance obtained from the signals sequentially output from an in-vehicle sensor 81 (vehicle speed sensor or the like) mounted on the subject vehicle 10. When a three-dimensional map provided by a road shape and a point group of feature points of a structure is used as map data, the locator ECU 34 may specify the position of the subject vehicle by using the three-dimensional map and the detection results of the surrounding monitoring sensor 40 without using the GNSS receiver 31.

The surrounding monitoring sensor 40 is an autonomous sensor configured to monitor the surrounding of the subject vehicle 10. The surrounding monitoring sensor 40 can detect moving objects and stationary objects in a detection range of a surrounding of the subject vehicle 10. The moving objects may include pedestrians, cyclists, non-human animals, and other vehicles 20, i.e., a preceding vehicle 21 and a following vehicle 22, and the stationary objects may include falling objects on the road, guardrails, curbs, road signs, lanes, lane markings, road markings such as a center divider, and structures beside the road. The surrounding monitoring sensor 40 provides detection information of detecting an object in the surrounding of the subject vehicle 10 to the first autonomous driving ECU 60, the second autonomous driving ECU 70, and the like through the communication bus 90. The surrounding monitoring sensor 40 includes, for example, a front camera 41, a millimeter-wave radar 42, a sound detecting sensor 43 and the like as detection configurations for object detection. The surrounding monitoring sensor 40 corresponds an acquisition unit of this disclosure.

The camera 41 has a front camera and a rear camera. The front camera outputs, as detection information, at least one of image data obtained by capturing a front range, i.e., front area, of the subject vehicle 10 or an analysis result of the image data. Similarly, the rear camera outputs, as detection information, at least one of imaging data obtained by imaging the rear range, i.e., rear area, of the subject vehicle 10 and analysis results of the imaging data.

A plurality of millimeter-wave radars 42 are arranged, for example, on front and rear bumpers of the subject vehicle 10 at intervals from one another. The millimeter-wave radars 42 emit millimeter waves or quasi-millimeter waves toward the front range, a front side range, a rear range, and a rear side range of the subject vehicle 10. Each millimeter-wave radar 42 generates detection information by a process of receiving millimeter waves reflected by moving objects, stationary objects, or the like. The surrounding monitoring sensor 40 may include other detection configurations such as LiDAR (light detection and ranging/laser imaging detection and ranging) that detects a point group of feature points of a construction, and a sonar that receives reflected waves of ultrasonic waves.

The sound sensor 43 is a sensing unit that senses sounds around the subject vehicle 10, and senses, for example, the siren sound of the emergency vehicle 23 approaching the subject vehicle 10 and the direction of the siren sound. The emergency vehicle 23 corresponds to a predetermined high-priority following vehicle 22, i.e., priority following vehicle, of this disclosure, and corresponds to, for example, a police car, an ambulance, a fire engine, and the like.

The in-vehicle communication device 50 is a communication module mounted on the subject vehicle 10. The in-vehicle communication device 50 has at least a V2N (vehicle to cellular network) communication function in accordance with communication standards such as LTE (long term evolution) and 5G, and sends and receives radio waves to and from base stations and the like in the surrounding of the subject vehicle 10. The in-vehicle communication device 50 may further have functions such as road-to-vehicle (vehicle to roadside infrastructure, hereinafter “V2I”) communication and inter-vehicle (vehicle to vehicle, hereinafter “V2V”) communication. The in-vehicle communication device 50 enables cooperation between a cloud system and an in-vehicle system (Cloud to Car) by V2N communication. By installing the in-vehicle communication device 50, the subject vehicle 10 becomes a connected car which is able to connect to the Internet. The in-vehicle communication device 50 corresponds to an acquisition unit of this disclosure.

The in-vehicle communication device 50 acquires road traffic congestion information such as road traffic conditions and traffic regulations from FM multiplex broadcasting and beacons provided on roads by using a VICS(R) (Vehicle Information and Communication System), for example.

Also, the in-vehicle communication device 50 communicates with a plurality of preceding vehicles 21 and following vehicles 22 via a predetermined center base station or between vehicles by using a DCM (Data Communication Module) or vehicle-to-vehicle communication, for example. The in-vehicle communication device 50 acquires information such as a vehicle speed and position of the other vehicles 20 traveling in front of and behind the subject vehicle 10, as well as the execution status of autonomous driving.

The in-vehicle communication device 50 provides information, i.e., surrounding information, of the other vehicle 20 based on the VICS or the DCM to the first and second autonomous driving ECUs 60 and 70, the HCU 160, and the like.

The first autonomous driving ECU 60 and the second autonomous driving ECU 70 mainly include a computer including processor 62, 72, memories 61, 71, input/output interface, and buses connecting them, respectively. The first autonomous driving ECU 60 and the second autonomous driving ECU 70 are ECUs capable of executing autonomous driving control that partially or substantially completely controls the traveling of the subject vehicle 10.

The first autonomous driving ECU 60 has a partially autonomous driving function that partially substitutes for the driving operation of the driver. For example, the first autonomous driving ECU 60 enables a manual operation or a partial autonomous driving control (advanced driving assistance) that entails a surrounding monitoring duty and is the level 2 or lower in autonomous driving levels defined by US Society of Automotive Engineers.

The first autonomous driving ECU 60 establishes multiple functional units that implement the above-mentioned advanced driving support by causing the processor 62 to execute multiple instructions according to the driving support program stored in the memory 61.

The first autonomous driving ECU 60 recognizes a traveling environment in the surrounding of the subject vehicle 10 based on the detection information acquired from the surrounding monitoring sensor 40. As one example, the first autonomous driving ECU 60 generates information (lane information) indicating relative position and shape of the left and right lane markings or roadsides of the vehicle lane (hereinafter referred to as a current lane) in which the subject vehicle 10 is currently traveling as an analyzed detection information. In addition, the first autonomous driving ECU 60 generates, as the analyzed detection information, information (preceding vehicle information) indicating the presence or absence of a preceding vehicle (other vehicle 20) with respect to the subject vehicle 10 in the current lane and a position and a speed of the preceding vehicle in the case that there is the preceding vehicle.

The first autonomous driving ECU 60 executes ACC (adaptive cruise control) that implements constant speed traveling of the subject vehicle 10 at a target speed or a following driving to the preceding vehicle based on a preceding vehicle information. The first autonomous driving ECU 60 executes LTA (Lane Tracing Assist) control for maintaining the traveling of the subject vehicle 10 in the vehicle lane based on a lane information. Specifically, the first autonomous driving ECU 60 generates a control command for acceleration/deceleration or steering angle, and sequentially provides them to the vehicle control ECU 80 described later. The ACC control is one example of longitudinal control, and the LTA control is one example of lateral control.

The first autonomous driving ECU 60 implements level 2 autonomous driving operation by executing both the ACC control and the LTA control. The first autonomous driving ECU 60 may be capable of implementing level 1 autonomous driving operation by executing either the ACC control or the LTA control.

On the other hand, the second autonomous driving ECU 70 has an autonomous driving function capable of substituting for the driving operation of the driver. The second autonomous driving ECU 70 enables autonomous driving control of level 3 or higher in the above-mentioned autonomous driving level. That is, the second autonomous driving ECU 70 enables autonomous driving in which the driver is permitted to interrupt monitoring of the surrounding, i.e., no obligation to monitor the surrounding. In other words, the second autonomous driving ECU 70 makes it possible to perform autonomous driving in which a second task is permitted.

The second task is an action other than a driving operation permitted to the driver, and is a predetermined specific action.

The second autonomous driving ECU 70 establishes multiple functional units that implement the above-described autonomous driving by causing the processor 72 to execute multiple instructions according to the autonomous driving program stored in the memory 71.

The second autonomous driving ECU 70 recognizes traveling environment of the surrounding of the subject vehicle 10 based on the subject vehicle position and map data obtained from the locator ECU 34, the detection information obtained from the surrounding monitoring sensor 40, the communication information obtained from the in-vehicle communication device 50, and the like. For example, the second autonomous driving ECU 70 recognizes the position of the current lane of the subject vehicle 10, the shape of the current lane, the relative positions and relative velocities of moving bodies, e.g., the other vehicle 20, in the surrounding of the subject vehicle 10, the traffic congestion, and the like.

In addition, the second autonomous driving ECU 70 performs identifying a manual driving area (MD area) and an autonomous driving area (AD area) in a traveling area of the subject vehicle 10, identifying a ST section and a non-ST section in the AD area, and sequentially outputting a recognition result to the HCU 160 described later.

The MD area is an area where the autonomous driving is prohibited. In other words, the MD area is an area where the driver performs all of the longitudinal control, lateral control, and surrounding monitoring of the subject vehicle 10. For example, the MD area is an area where the traveling road is a general road.

The AD area is an area where the autonomous driving is permitted. In other words, the AD area is an area in which the subject vehicle 10 can substitute at least one of the longitudinal control (forward-backward control), the lateral control (right-left control), or the surrounding monitoring. For example, the AD area is an area where the travelling road is a highway or a motorway.

The AD area is classified into a non-ST section, in which the autonomous driving at level 2 or lower is permitted, and an ST section, in which the autonomous driving at level 3 or higher is permitted. In the present embodiment, it is assumed that the non-ST section where the level 1 autonomous driving operation is permitted and the non-ST section where the level 2 automatic driving operation is permitted are equivalent.

The ST section is, for example, a traveling section (traffic congestion section) in which the traffic congestion occurs. Further, the ST section is, for example, a traveling section in which a high-precision map is prepared. The HCU 160 described later determines that the subject vehicle 10 is in the ST section when the traveling speed of the subject vehicle 10 remains within a range equal to or less than the determination speed for a predetermined period. Alternatively, the HCU 160 may determine whether the area is the ST section by using the subject vehicle position and traffic congestion information obtained from the in-vehicle communication device 50 via the VICS and the like. Furthermore, in addition to the traveling speed of the subject vehicle 10, i.e., a condition for traveling traffic congestion section, the HCU 160 may determine whether the area is the ST section under a condition such that the traveling road has two or more lanes, there is another vehicle 20 in the surrounding of the subject vehicle 10, i.e., in the same lane and the adjacent lanes, the traveling road has a median strip, or the map DB has high-precision map data.

In addition to the traffic congestion section, the HCU 160 may also detect a section where a specific condition other than traffic congestion is established regarding the surrounding environment of the subject vehicle 10, i.e., a section where a constant speed, a following driving, or a LTA, i.e., a lane keep traveling, is available without the traffic congestion on a highway as the ST section.

With the autonomous driving system including the above first and second autonomous driving ECUs 60 and 70, it is possible to at least perform an autonomous driving in the subject vehicle 10 which may be categorized at least level 2 or lower and equivalent to level 3 or higher.

The vehicle control ECU 80 is an electronic control device that performs acceleration and deceleration control and steering control of the subject vehicle 10. The vehicle control ECU 80 includes a steering ECU that performs steering control, a power unit control ECU and a brake ECU that perform acceleration and deceleration control, and the like. The vehicle control ECU 80 acquires detection signals output from respective sensors such as a steering angle sensor, the vehicle speed sensor, and the like mounted on the subject vehicle 10, and outputs a control signal to each of traveling control devices of an electronic control throttle, a brake actuator, an EPS (electronic power steering) motor, and the like. The vehicle control ECU 80 controls each driving control device so as to implement the autonomous driving according to the control instruction by acquiring control instructions of the subject vehicle 10 from the first autonomous driving ECU 60 or the second autonomous driving ECU 70.

Further, the vehicle control ECU 80 is connected to the in-vehicle sensor 81 that detects driving operation information of a driving member by the driver. The in-vehicle sensor 81 includes, for example, a pedal sensor that detects the amount of depression of the accelerator pedal, a steering sensor that detects the amount of steering of the steering wheel, and the like. In addition, the in-vehicle sensor 81 includes a vehicle speed sensor that detects the traveling speed of subject the subject vehicle 10, a rotation sensor that detects the operating rotation speed of the traveling drive unit, e.g., an engine, a traveling motor, and the like, a shift sensor that detects the shift position of the transmission, and the like. The vehicle control ECU 80 sequentially provides the detected driving operation information, vehicle operation information, and the like to the HCU 160.

Next, a configuration of the display apparatus 100 is described. The display apparatus 100 includes a plurality of display devices, as display units, and, the HCU 160, as a display control unit. In addition, the display apparatus 100 is provided with an audio device 140, an operation device 150, and the like.

The plurality of display devices includes a head-up display, i.e., hereinafter HUD, 110, a meter display 120, a center information display, i.e., hereinafter CID, 130, and the like. The plurality of display devices may further include respective displays EML, for left view, and EMR, for right view, of the electronic mirror system. The HUD 110, the meter display 120, and the CID 130 are display devices that present image contents such as still images or moving images to the driver as visual information. For example, images of the traveling road (traveling lane), the subject vehicle 10, the other vehicle 20, and the like are used as the image contents. Other vehicles 20 include a preceding vehicle 21 that runs beside and in front of the subject vehicle 10, a following vehicle 22 that runs behind the subject vehicle 10, an emergency vehicle 23, and the like.

The HUD 110 projects the light of the image formed in front of the driver onto a projection area defined by a front windshield of the subject vehicle 10 or the like based on the control signal and video data acquired from the HCU 160. The light of the image that has been reflected toward the vehicle interior by the front windshield is perceived by the driver seated in the driver's seat. In this way, the HUD 110 displays a virtual image in the space in front of the projection area. The driver visually recognizes the virtual image in the angle of view displayed by the HUD 110 in an overlapping manner with the foreground of the subject vehicle 10.

The meter display 120 and the CID 130 mainly include, for example, a liquid crystal display or an OLED (organic light emitting diode) display. The meter display 120 and the CID 130 display various images on the display screen based on the control signal and the video data acquired from the HCU 160. The meter display 120 is, for example, a main display unit installed in front of the driver's seat. The CID 130 is a sub-display unit provided in a central area in a vehicle width direction in front of the driver. For example, the CID 130 is installed above a center cluster in an instrument panel. The CID 130 has a touch panel function, and detects, for example, a touch operation and a swipe operation on a display screen by the driver or the like.

In the present embodiment, a case where the meter display 120 (main display unit) is used as the display unit is described as an example.

The audio device 140 has multiple speakers installed in the vehicle interior. The audio device 140 presents a notification sound, a voice message, or the like as auditory information to the driver based on the control signal and voice data acquired from the HCU 160. That is, the audio device 140 is an information presentation device capable of presenting information in a mode different from visual information.

The operation device 150 is an input unit that receives a user operation by the driver or the like. For example, user operations related to start and stop of each level of the autonomous driving function are input to the operation device 150. The operation device 150 includes, for example, a steering switch provided on a spoke unit of the steering wheel, an operation lever provided on a steering column unit, a voice input device for recognizing contents of a driver's speech, and an icon for touch operation on the CID 130 (switch), and the like.

The HCU 160 performs display control on the meter display 120 based on the information acquired by the locator 30, the surrounding monitoring sensor 40, the in-vehicle communication device 50, the first autonomous driving ECU 60, the second autonomous driving ECU 70, the vehicle control ECU 80, and the like, as described above. The HCU 160 mainly includes a computer including a memory 161, a processor 162, and a virtual camera 163, an input/output interface, a bus connecting these components, and the like.

The memory 161 is, for example, at least one type of non-transitory tangible storage medium, such as a semiconductor memory, a magnetic storage medium, and an optical storage medium, for non-transitory storing or memorizing computer readable programs and data. The memory 161 stores various programs executed by the processor 162, such as a presentation control program described later.

The processor 162 is a hardware for arithmetic processing. The processor 162 includes, as a core, at least one type of, for example, a CPU (central processing unit), a GPU (graphics processing unit), an RISC (reduced instruction set computer) CPU, and the like.

The processor 162 executes multiple instructions included in the presentation control program stored in the memory 161. Thereby, the HCU 160 provides multiple functional units for controlling the presentation to the driver. As described above, in the HCU 160, the presentation control program stored in the memory 161 causes the processor 162 to execute multiple instructions, thereby constructing multiple functional units.

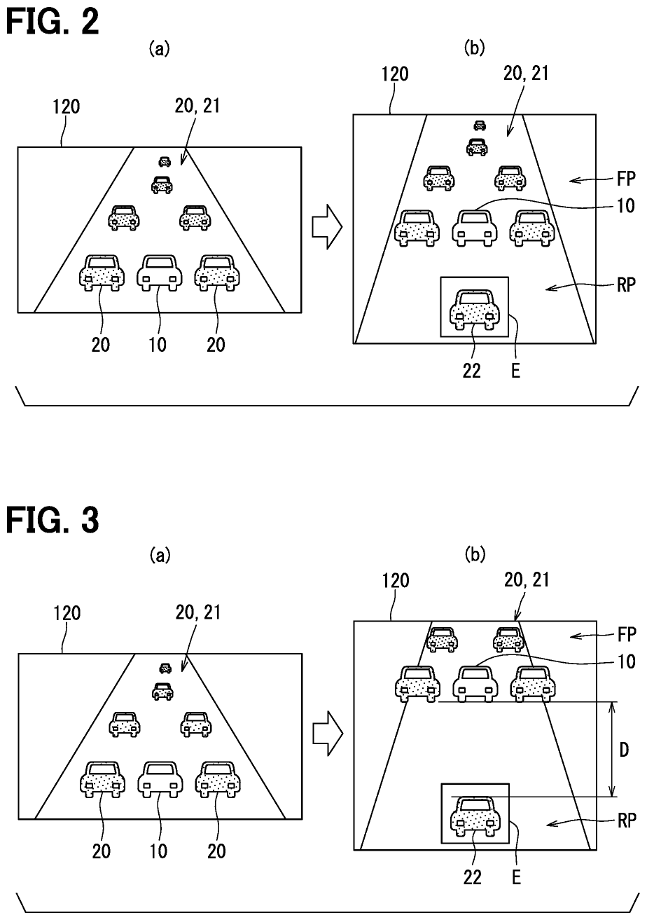

The virtual camera 163 is a camera set in a 3D space created by software. The virtual camera 163 generates an image of the subject vehicle 10 and the other vehicle 20, e.g., a bird's-eye view image in FIGS. 2, 3 and 4 by estimating positions of the other vehicles 20, i.e., a preceding vehicle 21 and a following vehicle 22, which is determined based on a coordinate position of the subject vehicle 10 as a reference, by using information from the locator 30, the surrounding monitoring sensor 40 (camera 41), the vehicle-mounted communication device 50, and the like. The virtual camera 163 can also form an image (two-dimensional view) obtained by capturing the images of the subject vehicle 10 and the other vehicle 20 in a bird's-eye view or in a two-dimensional view.

The HCU 160 acquires a traveling environment recognition result from the first autonomous driving ECU 60 or the second autonomous driving ECU 70. The HCU 160 recognizes a surrounding state of the subject vehicle 10 based on the acquired recognition result. Specifically, the HCU 160 recognizes the approach to the AD area, the entry into the AD area, the approach to the ST section (a traffic congestion section, a highway section, and the like), the entry into the ST section, and the like. The HCU 160 may recognize the surrounding state based on information directly obtained from the locator ECU 34, the surrounding monitoring sensor 40, or the like instead of the recognition results obtained from the first and second autonomous driving ECUs 60 and 70.

The HCU 160 determines that the autonomous driving operation is not permitted in the case that the subject vehicle 10 is traveling in the MD area. On the other hand, the HCU 160 determines that the autonomous driving operation at the level 2 or higher is permitted in the case that it is traveling in the AD area. Further, the HCU 160 determines that level 2 or lower autonomous driving can be permitted in the case that it is traveling in the non-ST section of the AD area, and determines that the level 3 or above autonomous driving can be permitted in the case that it is traveling in the ST section.

The HCU 160 determines the level of autonomous driving to be actually executed based on a surrounding state of the subject vehicle 10, a driver state, a level of currently permitted autonomous driving, input information to the operation device 150, and the like. That is, the HCU 160 determines execution of the level of autonomous driving if an instruction to start the currently permitted level of autonomous driving is acquired as input information.

The HCU 160 controls presentation of content related to the autonomous driving. Specifically, the HCU 160 selects a content to be presented on each one of the display devices 110, 120, and 130 based on various information.

The HCU 160 generates a control signal and video data to be provided to each one of the display devices 110, 120, and 130 and a control signal and audio data to be provided to the audio device 140. The HCU 160 outputs the generated control signal and each data to each presentation device, thereby presenting information on each of the display devices 110, 120, and 130.

The display apparatus 100 is configured as described above, and performs operations and effects described later with further reference to FIGS. 2, 3 and 4.

In this embodiment, examples are cases where the autonomous driving level 3, i.e., a congestion following driving, a high speed following driving, a constant speed driving, a driving within a lane, etc., is performed in the autonomous driving level 2 or lower mainly in a highway driving. Conditions for enabling the autonomous driving level 3, i.e., a predetermined condition for enabling autonomous driving, are, for example, that a predetermined vehicle speed condition is satisfied, there are multiple driving lanes, there is a median strip, and the like. The HCU 160 switches the display of the surrounding image of the subject vehicle 10 on the meter display 120 according to whether it is a normal driving, i.e., non-autonomous driving, or an autonomous driving.

1. Display In Normal Driving (During Non-Autonomous Driving)

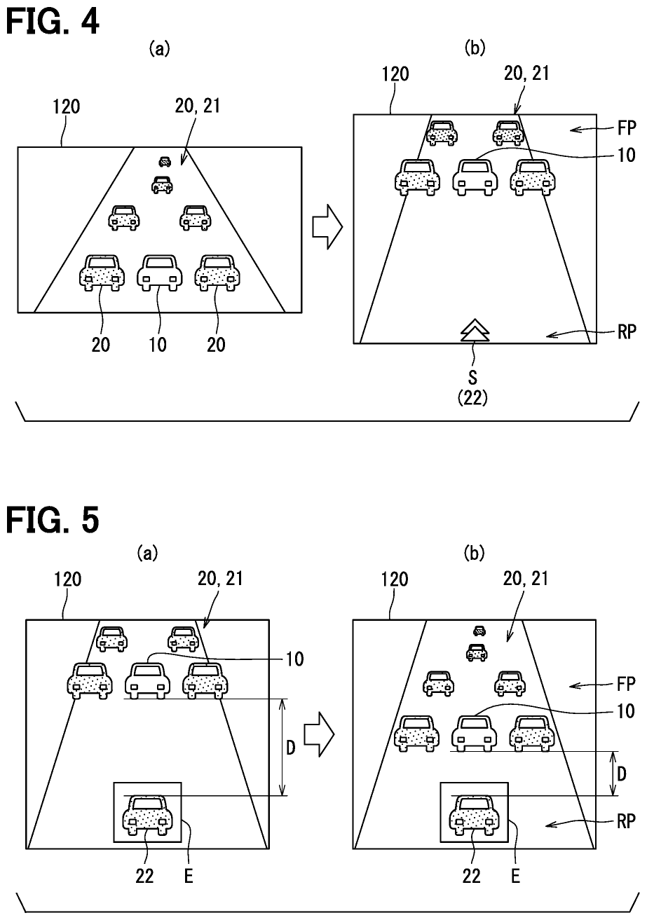

If the autonomous driving is not executed, the HCU 160 mainly displays a front area image FP including the subject vehicle 10, i.e., the other vehicle 20, that is, the preceding vehicle 21 on the meter display 120, based on the information obtained by the locator 30, the surrounding monitoring sensor 40 (mainly the front camera), and the in-vehicle communication device 50, as shown in (a) in FIG. 2, (a) in FIG. 3, and (a) in FIG. 4. The image displayed on the meter display 120 is, for example, a bird's-eye view that is viewed from a rear upper side of the subject vehicle 10 in the traveling direction. The image may be the two-dimensional view instead of the bird's-eye view.

2. Display In Autonomous Driving

If the autonomous driving is being executed, the HCU 160, i.e., the virtual camera 163, displays the front area image FP and a rear area image RP including the following vehicle 22 in a continuous and additional manner on the meter display 120 as shown in (b) in FIG. 2, (b) in FIG. 3, and (b) in FIG. 4 based on information obtained by the locator 30, the surrounding monitoring sensor 40 (mainly the camera 41), and the in-vehicle communication device 50. Overall images shown in (b) in FIG. 2, (b) in FIG. 3, and (b) in FIG. 4 are drawn as dynamic graphic models, for example, by obtaining coordinate information of the other vehicles 20 around the subject vehicle 10.

In addition, the HCU 160 widens the rear area so that the recognized following vehicle 22 enters the rear area (so that it can be visually recognized), as shown in (b) in FIG. 3. That is, the HCU 160 sets the rear area wider as the distance “D” between the subject vehicle 10 and the following vehicle 22 increases.

Further, if the distance “D” between the subject vehicle 10 and the following vehicle 22 is equal to or greater than a predetermined distance, the HCU 160 sets an area of the rear area to the maximum setting, and displays the following vehicle 22 by a simple display “S”, e.g., a triangular mark display, for simply indicating the existence as shown in (b) in FIG. 4. In the simple display “S”, the distance “D” between the subject vehicle 10 and the following vehicle 22 (the distance between them in the image) is not clearly displayed.

The HCU 160 performs by moving the position of the virtual camera 163, by widening or contracting the angle of view of the virtual camera 163, or by changing the orientation of the virtual camera 163, or by widening the display area in the two-dimension, i.e., in the case of two-dimensional display in a display shown in (b) in FIG. 2, (b) in FIG. 3, and (b) in FIG. 4.

Furthermore, the HCU 160 adds an emphasized display “E” to surround the following vehicle 22, e.g., a rectangular frame-shaped mark, in order to emphasize the following vehicle 22 as shown in (b) in FIG. 2, and (b) in FIG. 3.

As described above, in this embodiment, the HCU 160 displays the front area image FP including the subject vehicle 10 on the meter display 120 when the autonomous driving function is not demonstrated in the subject vehicle 10 based on the positional information and the surrounding information. Then, the HCU 160 displays the front area image FP and the rear area image RP including the following vehicle 22 in a continuous and additional manner on the meter display 120, i.e., the display unit, when the autonomous driving function is demonstrated in the subject vehicle 10.

As a result, since the rear area image RP including the subject vehicle 10 and the following vehicle 22 is displayed on the meter display 120 even during the autonomous driving in which the obligation to monitor the surrounding is unnecessary, it is possible to recognize a relationship of the subject vehicle 10 and the following vehicle 22.

In addition, since the HCU 160 widens the rear area so that the recognized following vehicle 22 enters the rear area (so that it can be visually recognized), it is possible to reliably display the following vehicle 22 relative to the subject vehicle 10.

Further, if the distance “D” between the subject vehicle 10 and the following vehicle 22 becomes equal to or greater than a predetermined distance, the HCU 160 sets an area of the rear area to the maximum, and displays the following vehicle 22 in a simplified display “S” only to indicate its existence. As a result, in the case that the following vehicle 22 is not very close to the subject vehicle 10, the presence of the following vehicle 22 is presented to the driver without clarifying the sense of distance from the subject vehicle 10, it is possible to make the driver to recognize the existence of the following vehicle 22.

Also, since the HCU 160 adds the emphasized display “E” to the following vehicle 22, it is possible to improve the degree of recognition of the following vehicle 22.

### Second Embodiment

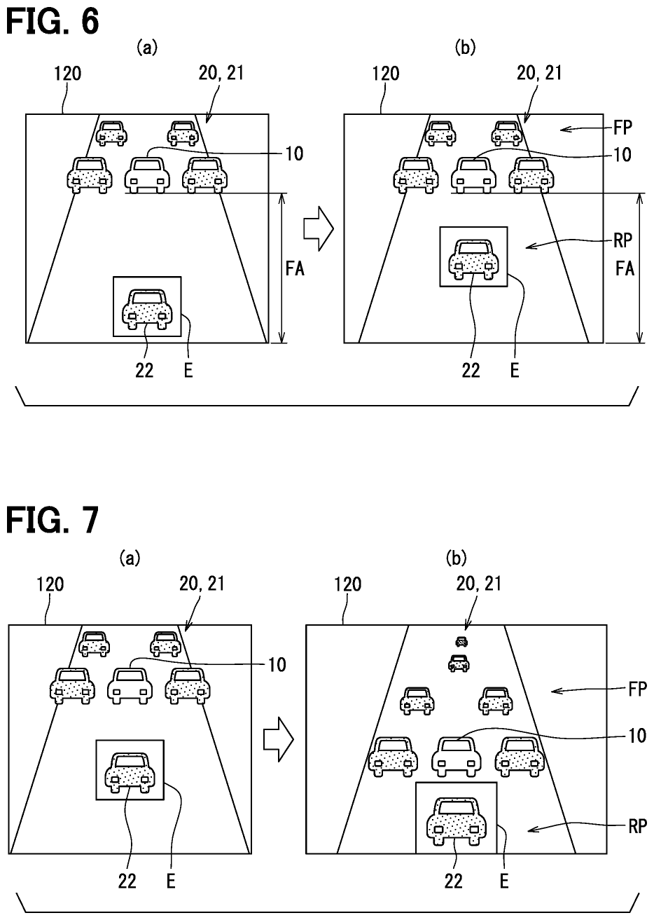

The second embodiment is shown in FIGS. 5, 6 and 7. The second embodiment changes the display form of the following vehicle 22 in the meter display 120 with respect to the first embodiment. Illustrations (a) in FIG. 5 and FIG. 6 shows the cases in which the distance “D” between the subject vehicle 10 and the following vehicle 22 is relatively long in the autonomous driving. Illustrations (b) in FIG. 5 and FIG. 6 shows the cases in which the distance “D” between the subject vehicle 10 and the following vehicle 22 is relatively short the autonomous driving. The following vehicle 22 is added with the emphasized display “E” similar to the first embodiment.

If the distance “D” fluctuates, the HCU 160 controls the position, angle of view, direction, etc. of the virtual camera 163 in the 3D space created by software, and captures the front area and the rear area to the subject vehicle 10. If the display of the following vehicle 22 is set to the lower side of the display area when the distance “D” is relatively long as shown in (a) in FIG. 5, the position of the vehicle 10 shifts downward within the display area when the distance “D” is relatively short as shown in (b) in FIG. 5, the display may be difficult to understand for the driver. In capturing the front area and the rear area with respect to the subject vehicle 10, the actual camera 41 may be used and synthesize the front area image and the rear area image front and rear area and output it.

Therefore, if the distance “D” fluctuates in this way, the HCU 160 fixes a setting of the virtual camera 163 and fixes the rear area to an area that can absorb the fluctuation of the distance “D”, as shown in FIG. 6. That is, the HCU 160 sets the rear area where the following vehicle 22 is displayed as a fixed area FA. Then, the HCU 160 fixes the position of the vehicle 10 in the front area, and displays the position of the following vehicle 22 with a fluctuation of the distance “D” with respect to the subject vehicle 10 so as to fluctuate within the rear area, i.e., in the fixed area FA.

This makes it possible for the driver to easily view the display of the following vehicle 22 with the fluctuation of the distance “D” with respect to the position of the subject vehicle 10.

If the distance “D” becomes equal to or less than a predetermined distance, the setting of the fixed area FA may be returned to canceled display as shown in FIG. 7.

### Third Embodiment

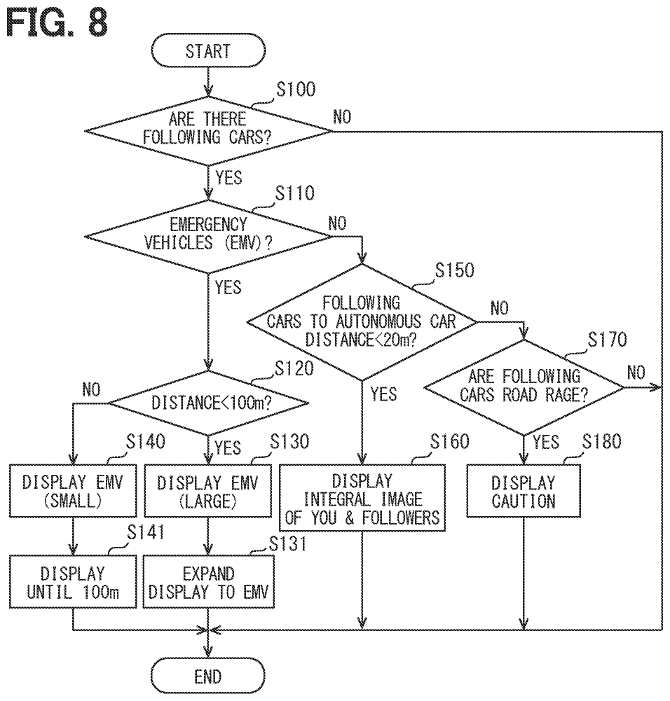

The thirteenth embodiment is shown in FIGS. 8 to 16. The third embodiment controls a display form according to the kind of following vehicle 22. FIG. 8 is a flow chart showing the procedure of display form control during the autonomous driving. The autonomous driving mode includes, e.g., a following driving (including a high speed and a low speed), constant speed driving, and a lane keep driving in a highway. A display form control performed by the HCU 160 is described below. In the flowchart of FIG. 8, the process from start to end is repeatedly executed at predetermined time intervals.

While the autonomous driving control is being executed, first, in a step S100 of the flowchart, the HCU 160 determines whether or not there is a following vehicle 22 from the information of the surrounding monitoring sensor 40, i.e., the camera 41. If the HCU 160 determines that there is a following vehicle 22, the process proceeds to a step S110, and if a negative determination is made, the control ends.

In the step S110, the HCU 160 determines whether the following vehicle 22 is an emergency vehicle 23, i.e., a priority following vehicle. The HCU 160 determines whether or not the following vehicle 22 is an emergency vehicle 23, i.e., a police car, an ambulance, a fire engine, etc., based on information from the sound sensor 43 in the surrounding monitoring sensor 40, such as siren sound and direction of the siren sound. If the HCU 160 makes an affirmative determination in the step S110, the process proceeds to a step S120, and if a negative determination is made, the process proceeds to a step S150. In steps S120 to S141, the following vehicle 22 is determined to be the emergency vehicle 23, and the following vehicle 22 is called the emergency vehicle 23.

In a step S120, the HCU 160 determines whether or not the distance between the subject vehicle 10 and the emergency vehicle 23 is less than a predetermined distance, e.g., 100 meters, based on information from the surrounding monitoring sensor 40, e.g., the camera 41.

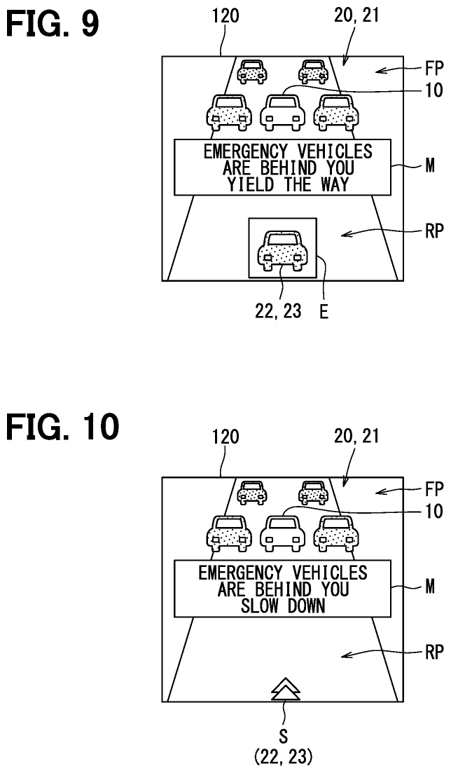

If an affirmative determination is made in the step S120, i.e., the distance is less than 100 meters, the HCU 160 displays the emergency vehicle 23 relatively large in a step S130, as shown in FIG. 9. Specifically, in a step S131, the HCU 160 widens the rear area to display up to the emergency vehicle 23 even if there are a plurality of following vehicles 22. Note that the HCU 160 displays the image of the emergency vehicle 23 with the emphasized display “E” in an additional manner.

Furthermore, the HCU 160 displays a message “M” indicating the relationship between the subject vehicle 10 and the emergency vehicle 23. In displaying the message “M”, the HCU 160 sets the position of the message “M” to a position that does not overlap the image of the subject vehicle 10 and the image of the emergency vehicle 23 among the display image. The message “M” may be, for example, “emergency vehicles are behind you, slow down.” The HCU 160 notifies the driver of the presence of the emergency vehicle 23 by the emphasized display “E” on the image of the emergency vehicle 23 and the message “M”.

Then, in order to give priority to the emergency vehicle 23, the HCU 160 issues an instruction to the second automatic driving ECU 70 to change the lane by the autonomous driving so that the emergency vehicle 23 can pass quickly.

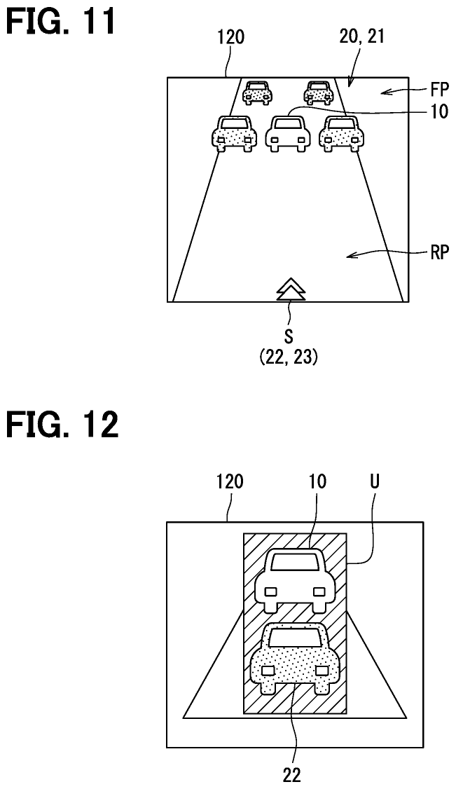

On the other hand, if a negative determination is made in the step S120, i.e., the distance is greater than 100 meters, the HCU 160 displays the emergency vehicle 23 relatively small in a step S140, as shown in FIG. 11. Specifically, in a step S141, the HCU 160 sets the rear area up to a range of 100 meters, and uses the simple display “S” in order to display an existence of the emergency vehicle 23 in the rear area, without clearly displaying the distance. It should be noted that the message “M” as described above (FIG. 9) is not displayed here because it still takes time for the emergency vehicle 23 to pass preferentially.

FIG. 10 shows an example of a display form in an intermediate case between FIG. 9 and FIG. 11, and is applicable to a determination of an intermediate level in a case that determination result in the step S120 is set to three levels. FIG. 10 shows an example in which the message “M” is displayed with the emergency vehicle 23 as a simple display “S”.

Next, after a negative determination is made in the step S110, in the step S150, the HCU 160 determines the following vehicle 22 performs the autonomous driving based on the information of the in-vehicle communication device 50, and whether a distance to the subject vehicle 10 is less than 20 meters based on the information of the surrounding monitoring sensor 40.

If an affirmative determination is made in the step S150, the HCU 160 determines that the following vehicle 22 is following the subject vehicle 10 by the automatic following driving. Then, in a step S160, the HCU 160 performs a unity image display “U” showing a sense of unity of the subject vehicle 10 and the following vehicle 22, as shown in FIGS. 12, 13, and 14.

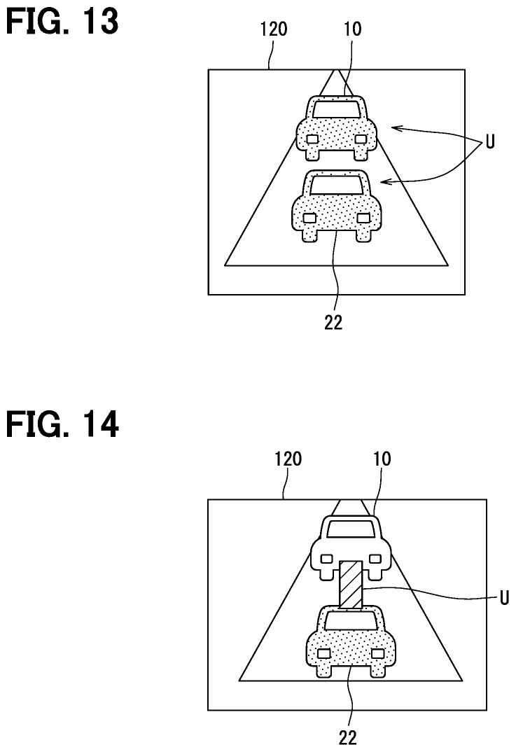

The unity image display “U” is a display that shows a situation in which the subject vehicle 10 and the following vehicle 22 immediately behind are paired by the following driving control. For example, in FIG. 12, the unity image display “U” is a display including a frame provided to enclose the subject vehicle 10 and the following vehicle 22, and an inside of the frame, i.e., a road surface, is colored with a predetermined color. Further, in FIG. 13, the unity image display “U” is a display in which both the subject vehicle 10 and the following vehicle 22 are shown by the same design. FIG. 14 also shows that the subject vehicle 10 and the following vehicle 22 are connected (towed).

In addition, in a step S160, the message “M” may be displayed in the same manner as in the steps S130 and S131. The message “M” is, for example, “The following vehicle 22 is automatically following the subject vehicle 10.”

On the other hand, if a negative determination is made in the step S150, the HCU 160 determines in a step S170 whether or not the following vehicle 22 is a vehicle called road rage. The HCU 160 determined whether or not the following vehicle 22 is a vehicle of road rage, based on information from the surrounding monitoring sensor 40, such as the current vehicle speed, the inter-vehicle distance between the subject vehicle 10 and the following vehicle 22, whether or not the following vehicle 22 is meandering, whether or not the high beam from the following vehicle 22 is present, number of the other vehicle 20 on the surrounding of the subject vehicle 10, i.e., whether the following vehicle 22 is single or not, a lane position in which the following vehicle 22 is driving, i.e., whether a frequent lane change or not, and the like.

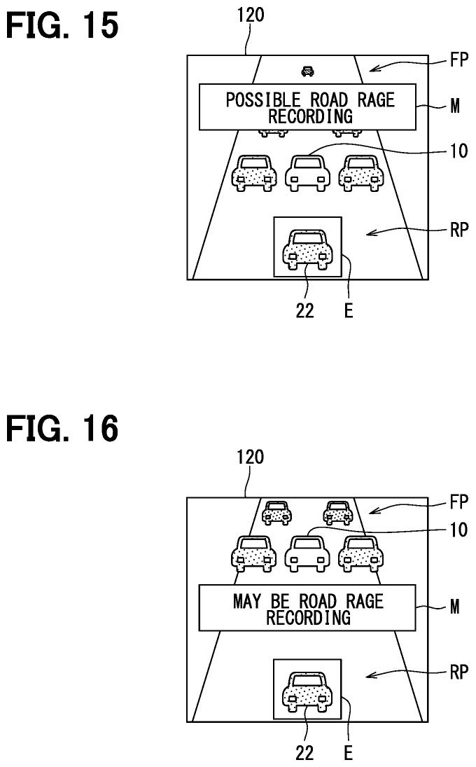

if an affirmative determination is made in a step S170, the HCU 160 displays a warning to the driver in a step S180, as shown in FIG. 15 and FIG. 16. Specifically, the HCU 160 displays the following vehicle 22 (a road rage vehicle) with the emphasized display “E” added to the rear area. Also, the HCU 160 displays the message “M” so as not to overlap the subject vehicle 10 and the following vehicle 22. FIG. 15 shows an example in which the message “M” is displayed in the front area ahead of the subject vehicle 10, and FIG. 16 shows an example in which the message “M” is displayed between the subject vehicle 10 and the following vehicle 22.

The message “M” may be, for example, “possible road rage, recording” in FIG. 15, or “may be road rage, recording” in FIG. 16.

If a negative determination is made in the step S170, the HCU 160 terminates this control.

As described above, in this embodiment, the display form is controlled according to the type of the following vehicle 22, and the driver can recognize the following vehicle 22 even during the autonomous driving, and take the necessary measures.

If the following vehicles 22 include an emergency vehicle 23 having a predetermined high priority, i.e., a priority following vehicle, the HCU 160 displays up to the emergency vehicle 23 in the rear area. This allows the driver to reliably recognize the presence of the emergency vehicle 23.

In addition, the HCU 160 performs the emphasized display “E” that emphasizes the emergency vehicle 23. This allows the driver to reliably recognize the emergency vehicle 23. If the following vehicle 22 is a vehicle of road rage, the driver's degree of recognition can be enhanced by performing the emphasized display “E” in the same manner.

Further, the HCU 160 performs the unity image display “U” showing a sense of unity of the subject vehicle 10 and the following vehicle 22 in the case that the following vehicle 22 performs the automatic following driving to the subject vehicle 10. This allows the driver to recognize that the following vehicle 22 performs the automatic following driving.

Furthermore, the HCU 160 displays the message “M” indicating the relationship between the subject vehicle 10 and the following vehicle 22. This allows the driver to recognize the relationship with the following vehicle 22 in detail.

Also, in displaying the message “M”, the HCU 160 displays the image so as not to overlap the subject vehicle 10 and the following vehicle 22. Accordingly, the display of the positional relationship between the subject vehicle 10 and the following vehicle 22 is not obstructed.

In the above embodiment, the control of the display form (display of the following vehicle 22) is performed by starting the processing according to the flowchart shown in FIG. 8. However, the present invention is not limited to this, and a driver camera that captures the driver's face may be provided, and if the number of times the driver's sight looks at the rearview mirror exceeds a threshold value per unit time, the following vehicle 22 display processing is executed (started).

### Fourth Embodiment

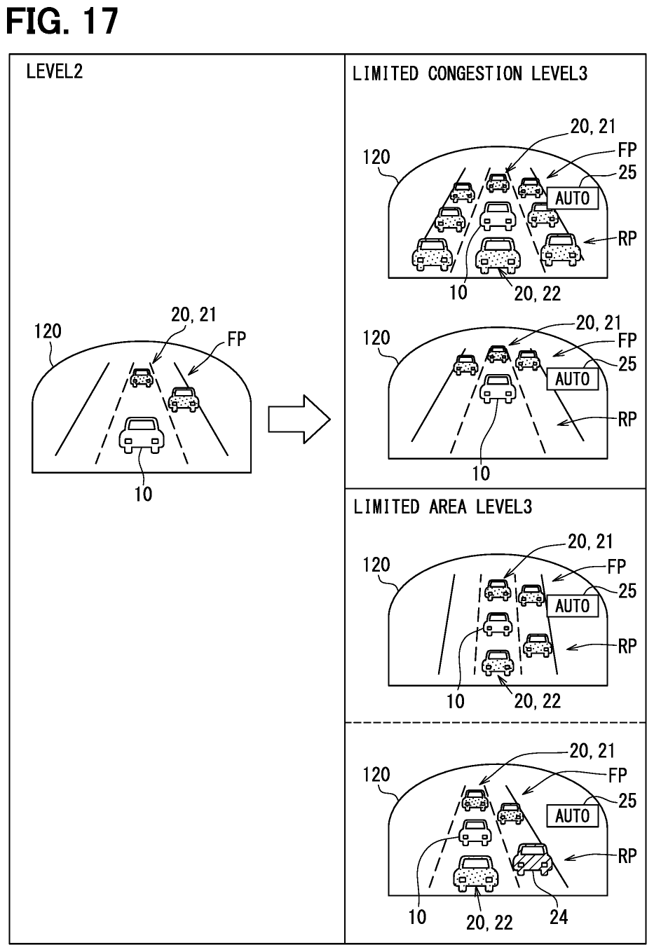

The fourth embodiment is shown in FIG. 17. In the fourth embodiment, the HCU 160 acquires various information from the locator 30, the surrounding monitoring sensor 40, the in-vehicle communication device 50, the first and second autonomous driving ECUs 60 and 70, the vehicle control ECU 80, and the like. Among various information, the HCU 160 switches the display form of the surrounding image displayed on the display unit according to the position information and the traveling state of the subject vehicle 10, the levels, i.e., Level 1, Level 2, or Level 3 and higher, of the autonomous driving which is set based on the surrounding information, the traveling state of the subject vehicle 10 (traffic congestion, high speed driving, etc.), and the situation of surrounding vehicles, i.e., the preceding vehicle 21 and the following vehicle 22. The surrounding image is an image around the subject vehicle 10 and is an image showing a relationship among the subject vehicle 10 and the surrounding vehicles 21 and 22. For example, the meter display 120 is used as the display unit.

As shown on the left side of FIG. 17, if the subject vehicle 10 is traveling under the autonomous driving level 2 (or also including the autonomous driving level 1), the HCU 160 displays the front area image FP including the subject vehicle 10. At this time, the front area image FP uses a bird's-eye view representation captured from a rear above of the subject vehicle 10.

On the other hand, as shown on the right side of FIG. 17, if the subject vehicle 10 reaches the autonomous driving level 3 or higher, the HCU 160 displays the rear area image RP in addition to the front area image FP.

As shown in the upper right part of FIG. 17, when a level of the autonomous driving is the congestion limited level 3, the HCU 160 displays, if there is a following vehicle 22, the rear area image RP up to the rear end of the following vehicle 22, and displays, if there is no following vehicle 22, a wider area than an area assuming the following vehicle 22. The bird's-eye view representation is used for the surrounding image at this time. If the following vehicle 22 is approaching from behind at high speed, the rear area may be displayed in a widened manner. Also, the surrounding image may be displayed on the CID 130.

In addition, as shown in the middle part of the right side of FIG. 17, it is the autonomous driving level 3 or higher in an area limited level 3 which is the autonomous driving is permitted in a predetermined specific area, e.g., a specific section in a highway, the HCU 160 displays the surrounding image by the two-dimensional image in which the subject vehicle 10 is captured from above and the subject vehicle 10 is placed in a center. The surrounding image may be displayed on the CID 130. Further, if there is no following vehicle 22, the subject vehicle 10 may be displayed at a position corresponding to the rear (lower side of the image) in the surrounding image.

Also, as shown in the lower right part of FIG. 17, if there in an approaching of the dangerous vehicle 24, e.g., a road rage vehicle, a high speed approaching vehicle, an approaching vehicle on the same lane close to the subject vehicle 10, which may be highly dangerous to the subject vehicle 10, the HCU 160 displays so as to place the dangerous vehicle 24 in the rear area image RP. The HCU 160 places the subject vehicle 10 in a center of the surrounding image at a stage before the dangerous vehicle 24 approaches, and if the dangerous vehicle 24 approaches, shifts the position of the subject vehicle 10 from the center so as to place the dangerous vehicle 24 surely within the surrounding image.

At this time, the HCU 160 performs an identification display (a display of

AUTO 25) to indicate (identify) that the autonomous driving level 3 has been entered during the autonomous driving level 3.

According to this embodiment, since the display form relating to a relationship of the subject vehicle 10 and the surrounding vehicles 21 and 22 is switched in accordance with the levels of the autonomous driving of the subject vehicle 10, the traveling state (traffic congestion, high speed driving, etc.), and the situation of the surrounding vehicles 21 and 22, it is possible to appropriately recognize a relationship of the subject vehicle 10 and the surrounding vehicles 21 and 22.

At the congestion limited level 3, the surrounding image is displayed by the bird's-eye view representation, and a size of the rear area is changed according to a presence or an absence of the following vehicle 22, so that the approaching following vehicle 22 can be easily recognized.

In addition, at the area limited level 3, since the two-dimensional display is used, it is possible to recognize the surrounding vehicles 21 and 22 in a wide range, and in particular, it is possible to make it easy to recognize the behavior of the following vehicle 22 approaching at high speed and the preceding vehicle 21 in front, left and right.

Also, if the dangerous vehicle 24 approaches, since it is displayed so as to be included in the rear area image RP, it may be possible to eliminate anxiety.

### Fifth Embodiment

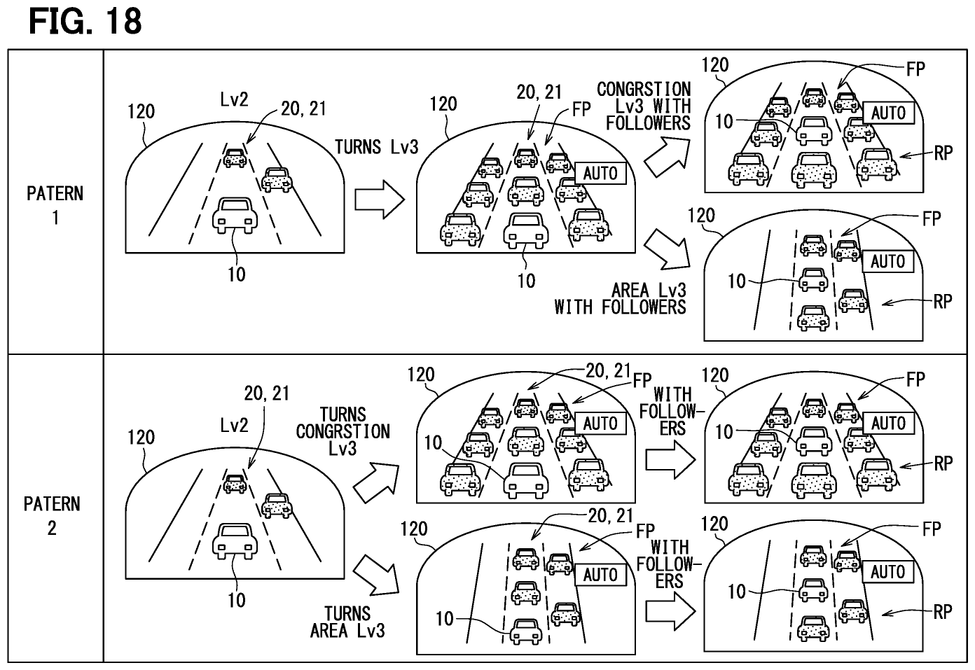

The fifth embodiment is shown in FIG. 18. In the fifth embodiment, the HCU 160 adjusts the switching timing of the surrounding image display form based on the timing at which the level of autonomous driving, the traveling state of the subject vehicle 10, and the situations of the surrounding vehicles 21 and 22 are determined.

In a pattern “1” of FIG. 18, if a signal permitting the autonomous driving level 3 is received from the first and second autonomous driving ECUs 60 and 70 at autonomous driving level 2, the HCU 160 switches display to the front area image FP in a bird's-eye view representation. This surrounding image includes both cases of a traffic congestion driving and an area limited driving.

After that, if it receives that the autonomous driving level 3 is the congestion limited level 3 or the area limited level 3, the HCU 160 switches the display to the surrounding image in a congestion, i.e., a bird's-eye view representation or switches the display to the surrounding image in an area limited, i.e., a two-dimensional representation at that timing. The surrounding image in this case include the front area image FP and the rear area image RP.

On the other hand, in a pattern “2” of FIG. 18, if a signal permitting the congestion limited level 3 or the area limited level 3 from the first and second autonomous driving ECUs 60 and 70 at the autonomous driving level 2, the HCU 160 switches the display to the front area image FP in the bird's-eye view representation at the congestion limit level 3. Alternatively, if it is the area limited level 3, the HCU 160 switches to displaying the front area image FP in the two-dimensional representation.

After that, if it receives a signal indicating that there is a following vehicle 22, the HCU 160 switches to displaying the front area image FP and the rear area image RP at the time of traffic congestion, or switches to displaying the front area image FP and the rear area image RP at the time of the area limited.

As a result, the HUC 160 can reasonably switch the display form according to the timing of signals relating to the autonomous driving received from the first and second autonomous driving ECUs 60 and 70.

### Sixth Embodiment

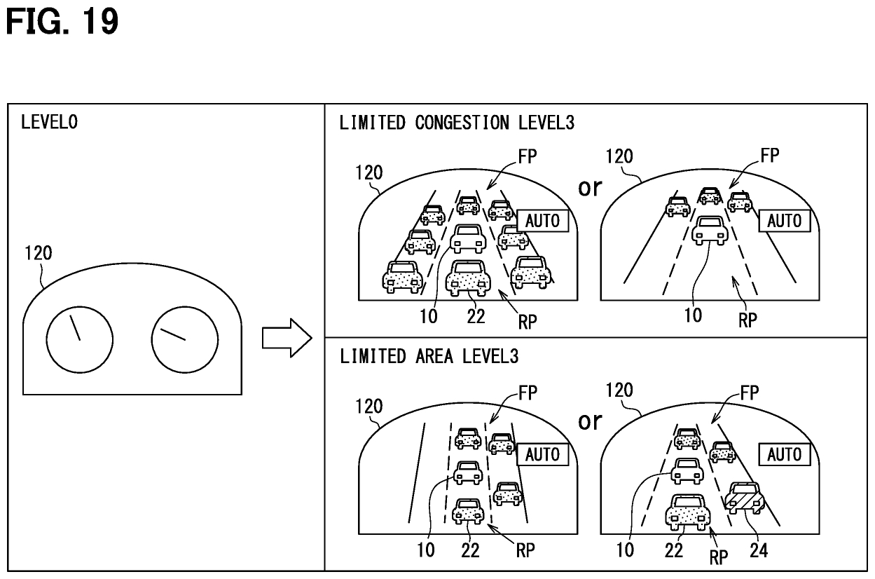

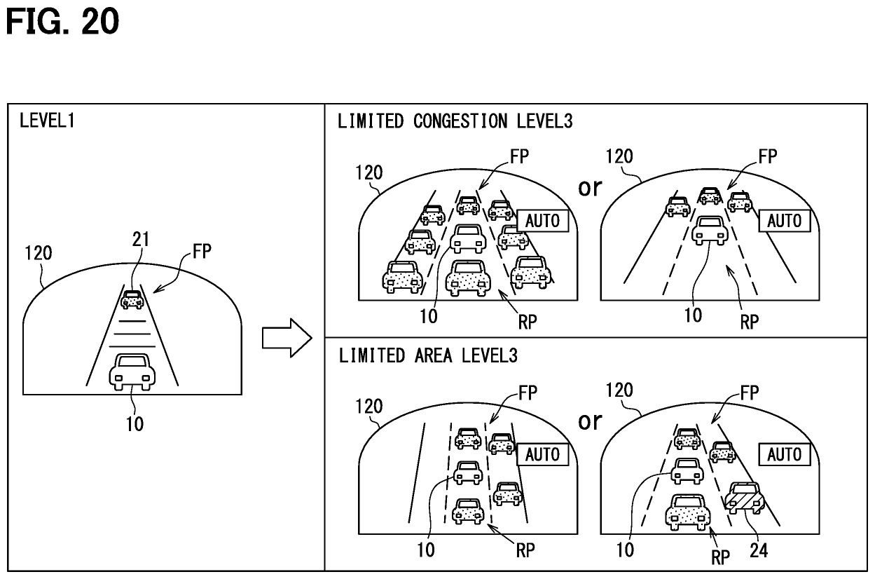

The sixth embodiment is shown in FIG. 19 and FIG. 20. The sixth embodiment shows an example in which the HCU 160 performs a switching of the display form from the manual driving, i.e., the autonomous driving level 0, or the autonomous driving level 1 to the autonomous driving level 3, compared with switching the display form from a state of the autonomous driving level 2 to the autonomous driving level 3 as the autonomous driving level as described above.

As shown in FIG. 19, at the autonomous driving level 0, the HCU 160 displays the original meters (a speedometer, a tachometer, etc.) on the meter display 120. Then, if the autonomous driving level reaches the congestion limited level 3, the HCU 160 switches the display to the front area image FP and the rear area image RP in the bird's-eye view representation. This example shows a case where there is a following vehicle 22 and a case where there is none.

Further, if the autonomous driving level becomes the area limited level 3 at the autonomous driving level 0, the HCU 160 switches the display to the front area image FP and the rear area image RP in the two-dimensional representation or the bird's-eye view representation. This example shows a case where there is a following vehicle 22.

On the other hand, the HCU 160 displays the preceding vehicle 21 involved in the following driving on the meter display 120 at the autonomous driving level 1, e.g., the following driving, as shown in FIG. 20. Then, similar to the above, if the autonomous driving level reaches the congestion limited level 3, the HCU 160 switches the display to the front area image FP and the rear area image RP in the bird's-eye view representation. This example shows a case where there is a following vehicle 22 and a case where there is none.

Further, if the autonomous driving level becomes the area limited level 3 at the autonomous driving level 1, the HCU 160 switches the display to the front area image FP and the rear area image RP in the two-dimensional representation or the bird's-eye view representation. This example shows a case where there is a following vehicle 22.

As a result, even if the autonomous driving level is the level 0 or the level 1, if the autonomous driving level shifts to the level 3, it switches to the surrounding image including the front area image FP and the rear area image RP, therefore, it is possible to appropriately recognize the relationship among the subject vehicle 10 and the surrounding vehicles 21 and 22.

### Seventh Embodiment

In the above embodiment (fourth embodiment), the display form of the surrounding image at the autonomous driving level 3 may be a bird's-eye view representation, may be a two-dimensional representation, or may be a two-dimensional representation in the case that a display area is widened more than that of the bird's-eye view representation.

Although the bird's-eye view representation enables realistic image representation, due to a large amount of image data, a load on image processing is increased, as a result, there may be a problem of smooth image representation. Therefore, if you want to pursue reality, the two-dimensional representation is sufficient. Therefore, it is preferable to use the bird's-eye view representation and the two-dimensional representation properly according to the surrounding situation. In this case, when switching between the bird's-eye view representation and the two-dimensional representation, smooth switching should be performed.

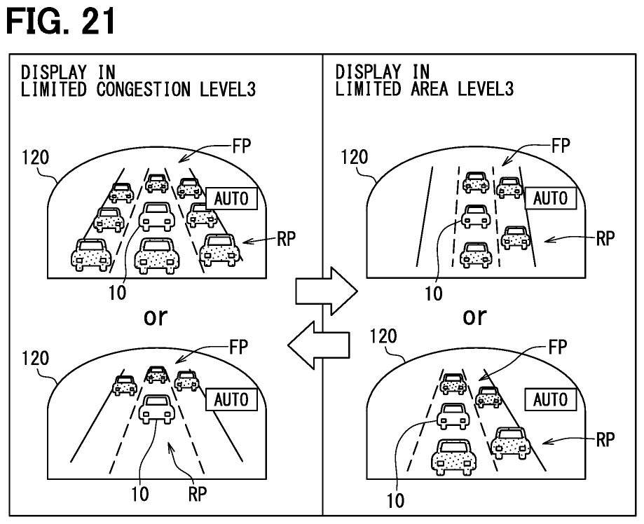

FIG. 21 shows a case where the surrounding image is switched between the bird's-eye view representation and the two-dimensional representation according to the surrounding conditions of the subject vehicle 10. FIG. 21 shows, for example, a surrounding image at the congestion limited level 3 and a surrounding image at the area limited level 3.

At the congestion limited level 3, for example, if there is no traffic congestion other than the subject lane, it is preferable to switch to the two-dimensional representation similar to the area limited level 3. Also, if a traffic congestion occurs at the area limited level 3, it is preferable to switch to the bird's-eye view representation similar to the congestion limited level 3.

In addition, the HCU 160 may be better to increase a frequency of use of the bird's-eye view representation out of the bird's-eye view representation and the two-dimensional representation by, for example, lowering a determination threshold value for using the bird's-eye view representation as the vehicle speed of the subject vehicle 10 and the following vehicle 22 increases.

Further, the HCU 160 preferably increases an area of the rear area image RP as the distance between the subject vehicle 10 and the following vehicle 22 increases.

### Eighth Embodiment

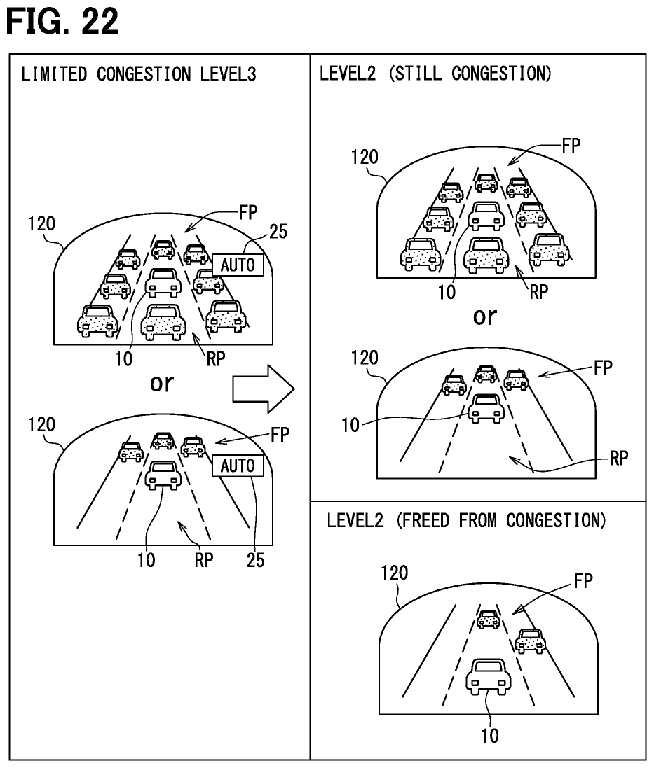

The eighth embodiment is shown in FIGS. 22 to 25. In the eighth embodiment, the HCU 160 displays a surrounding image in accordance with the congestion limited level 3 in the traffic congestion in which the driver's obligation to monitor the surrounding is unnecessary, as the level of the autonomous driving. Then, if the traffic congestion is not resolved even if it transits to the autonomous driving level 2 or lower in the traffic congestion in which the driver's obligation to monitor the surrounding is necessary, the HCU 160 continues to display the surrounding image of the congestion limited level 3, and displays the surrounding image according to the autonomous driving level 2 or lower if the traffic congestion is resolved.

FIG. 22 shows a case where it transits from the congestion limited level 3 to the autonomous driving level 2.

As shown on the left side of FIG. 22, at the congestion limited level 3, the HCU 160 displays the front area image FP and the rear area image RP in the bird's-eye view representation as the surrounding images (including the presence or absence of the following vehicle 22). At this time, the HCU 160 performs an identification display (a display of AUTO 25) to indicate (identify) that the autonomous driving level 3 has been entered during the traffic congestion limited level 3.

Then, as shown in the upper right part of FIG. 22, if the congestion does not resolve even after transiting to the autonomous driving level 2, the HUC 160 continues the display form at the congestion limited level 3 as it is. It should be noted that the display of AUTO 25 is not displayed during the transition to the autonomous driving level 2.

If the traffic congestion does not disappear even after transiting from the congestion limited level 3 to the autonomous driving level 2, the decrease of the number of lanes, the other vehicles 20 may join, etc., may be considered as a reason, and since there is a possibility of interrupting the surrounding of the subject vehicle 10, it is preferable to display not only the front area image FP but also the rear area image RP.

In the congestion limited level 3 and the autonomous driving level 2, it makes possible to distinguish between the congestion limited level 3 and the autonomous driving level 2 by displaying AUTO 25 at the congestion limited level 3.

On the other hand, as shown in the lower right part of FIG. 22, if it transits to the autonomous driving level 2 and the congestion is resolved, the HCU 160 switches to display the front area image FP according to the autonomous driving level 2. It should be noted that the display of AUTO 25 is not displayed during the transition to the autonomous driving level 2.

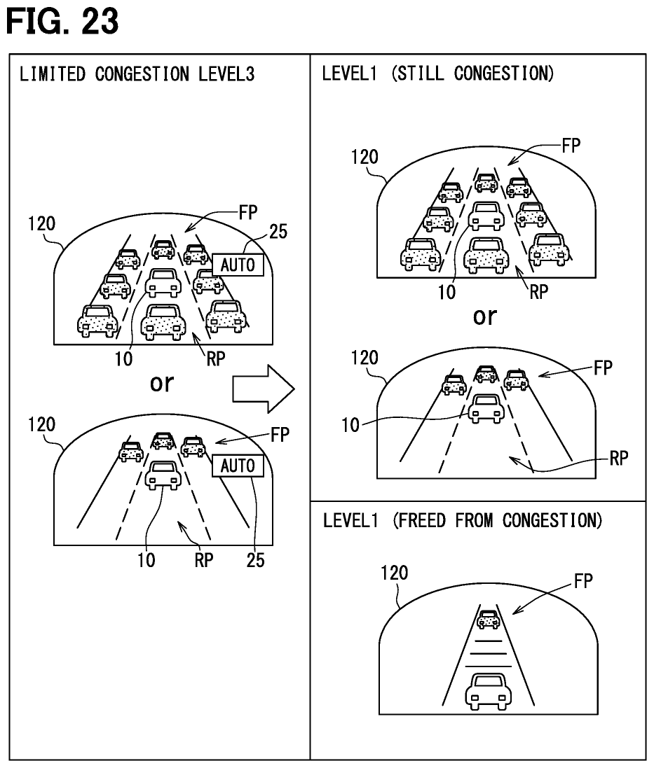

FIG. 23 shows a case where it transits from the congestion limited level 3 to the autonomous driving level 1. The display form when the congestion is not resolved is the same as in the case of FIG. 22 above. Further, if the traffic congestion is resolved, for example, the preceding vehicle 21 involved in the following driving is displayed as the front area image FP.

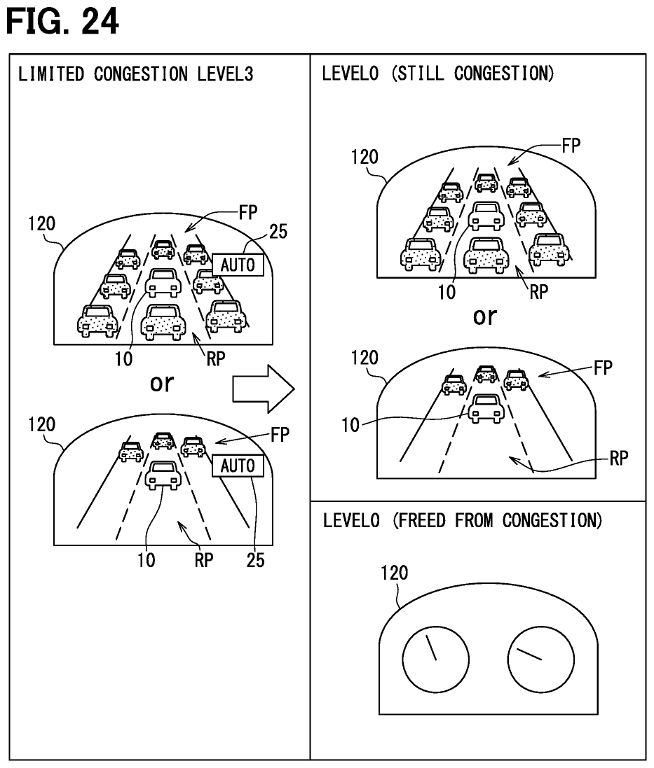

Also, FIG. 24 shows a case in which it transits from the congestion limited level 3 to the autonomous driving level 0, i.e., the manual driving. The display form when the congestion is not resolved is the same as in the case of FIG. 22 above. Further, if the congestion is resolved, the original meter display (the speedometer, the tachometer, etc.) is displayed.

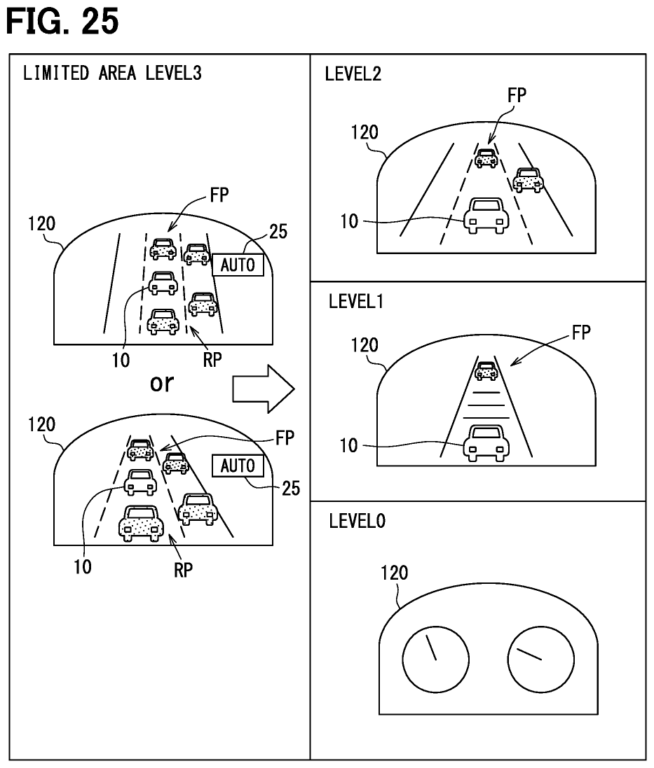

As a reference, FIG. 25 shows a case where it transits from the area limited level 3 to the autonomous driving level 2, level 1, and level 0, i.e., the manual driving. At the area limited level 3, the front area image FP and the rear area image RP are displayed by the two-dimensional representation or the bird's-eye view representation (with a display of AUTO25). Then, if it transits to the autonomous driving level 2, the front area image FP, i.e., a plurality of preceding vehicles 21, is displayed, if it transits to the autonomous driving level 1, the front area image FP, i.e., the preceding vehicle 21 in the following driving, is displayed, and it if transit to the autonomous driving level 0, the original meter display is displayed. At the autonomous driving level 2, level 1, and level 0, the display of AUTO 25 is hidden.

### Ninth Embodiment

In the ninth embodiment, switching between the display relating to the second task at the autonomous driving level 3 and the display of the surrounding image is described.

If a level of the autonomous driving transits to the autonomous driving level 3, in which the driver's obligation to monitor the surrounding is unnecessary, the HCU 160 performs a display relating to a second task that is permitted as an action other than driving for the driver. Then, the HCU 160 switches the display relating to the second task to the surrounding image when there is another vehicle 20 approaching or when there is another vehicle 20 traveling at a high speed.

A display unit which displays the second task may be the meter display 120 or the CID 130. For example, if the CID 130 displays relating to the second task, e.g., playing a movie, etc., and there is an approaching other vehicle 20 or a fast-moving other vehicle 20, the HCU 160 switches the display of the CID 130 to the surrounding image. The surrounding images may be the front area image FP and the rear area image RP, or only the rear area image RP.

In addition, if a level of the autonomous driving transits to the autonomous driving level 3, in which the driver's obligation to monitor the surrounding is unnecessary, and the driver begins the second task, i.e., an operation of a smartphone, that is permitted as an action other than driving, the HCU 160 switches the surrounding image to a predetermined minimum display content. In addition, if the driver interrupts the second task, e.g., the driver raises his/her face, etc., and if there is another vehicle 20 approaching, or if there is another vehicle 20 traveling at a high speed, the HCU 160 switches the display from the minimal content to the surrounding image. The surrounding images may be the front area image FP and the rear area image RP, or only the rear area image RP.

In this way, the HCU 160 switches, at the autonomous driving level 3, the display from the display relating to the second task or the minimal content relating to the second task on the display unit, i.e., the meter display 120, the CID 130 and the like, to the surrounding image based on the situation of the surrounding vehicles 21 and 22 and by interrupting the second task of the driver, etc. Therefore, even at the autonomous driving level 3, it is possible to appropriately recognize the relationship among the subject vehicle 10 and the surrounding vehicles 21 and 22.

### Tenth Embodiment

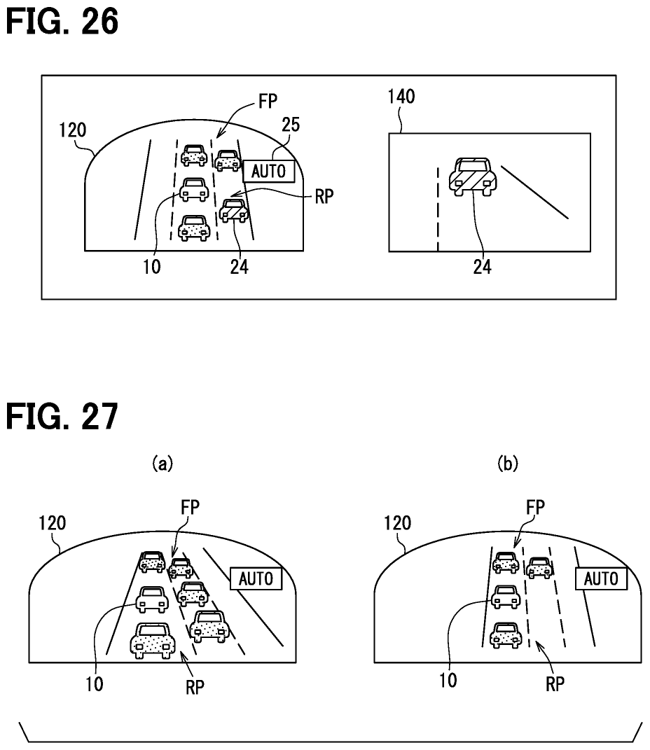

The tenth embodiment is shown in FIG. 26. The tenth embodiment has an electronic mirror display 170 which displays surrounding vehicles 21 and 22 on the rear side of the subject vehicle 10 as a display unit. The electronic mirror display 170 is provided adjacent to the meter display 120, for example. Then, if a dangerous vehicle 24, which may be dangerous to the subject vehicle 10, approaches, the HCU 160 displays the dangerous vehicle 24 on both the meter display 120 and the electronic mirror displayl70 in an emphasized manner, at the autonomous driving level 3, i.e., with the display of AUTO 25 on the meter display 120.

The surrounding images on the meter display 120 can be, for example, the front area image FP and the rear area image RP displayed by the two-dimensional representation. Also, the emphasized display can be, for example, the highlighting display “E” described in the first embodiment.

Thus, if the dangerous vehicle 24 approaches, since the dangerous vehicle 24 is displayed by both the meter display 120 and the electronic mirror display 170, it is possible to remove anxiety.

### Eleventh Embodiment

The eleventh embodiment is shown in FIG. 27. In the eleventh embodiment, in the autonomous driving level 3, the HCU 160 switches the display form of the surrounding image to the bird's-eye view representation captured from a rear above the subject vehicle 10 if a lane next to the subject vehicle 10 is congested ((a) in FIG. 27), and switches to the two-dimensional view representation captured from above the subject vehicle 10 if a lane next to the subject vehicle 10 is not congested ((b) in FIG. 27).

Thereby, if an adjacent lane is congested, it is considered that a possibility of an interruption is low. At this time, since the surrounding image is represented by the bird's-eye view, attention may be directed mainly to the other vehicle 20 on the rear side. Also, if the adjacent lane is not congested, it is considered that there is a possibility of an interruption by a vehicle which is in a high-speed and is approaching. At this time, since the surrounding image is represented by the two-dimensional manner, attention may be directed to a wider area.

### Twelfth Embodiment

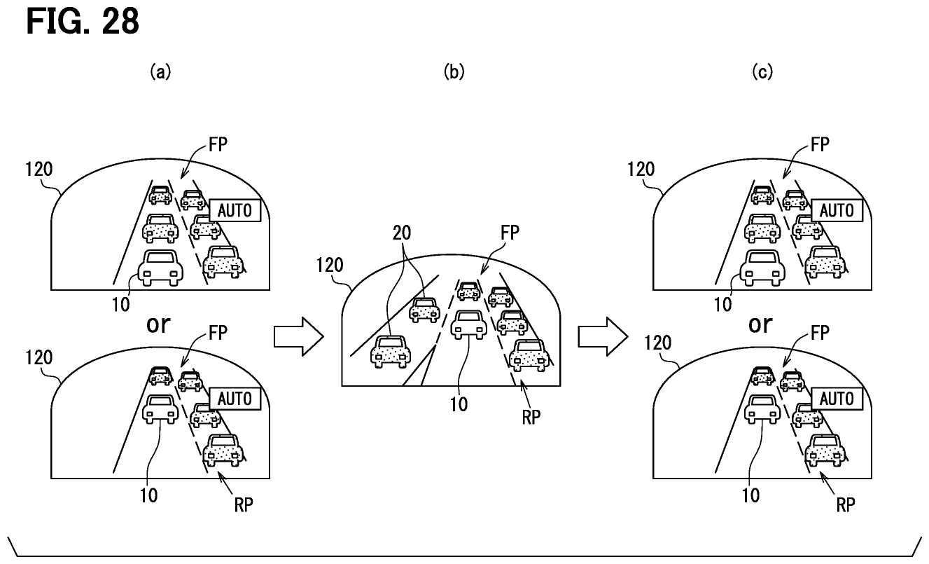

The twelfth embodiment is shown in FIGS. 28 to 31. In the twelfth embodiment, if there is another vehicle 20 about to join at a merging point, the HCU 160 displays the other vehicle 20 in addition to the surrounding image.

FIG. 28 shows a case where there is no following vehicle 22 due to traffic congestion. (a) in FIG. 28 shows a surrounding image represented by the bird's-eye view at the congestion limited level 3. The position of the subject vehicle 10 can be the lower side of the surrounding image or the center of the surrounding image. (b) in FIG. 28 shows a surrounding image at a merging point. The congestion limited level 3 is changed to the autonomous driving level 2 at the merging point. The other vehicles 20 about to join are displayed in the surrounding image. At this time, the position of the subject vehicle 10 should be slightly moved to the right side so that the other vehicle 20 on the left side, which is on the merging side, can be reliably displayed. Further, the surrounding image may be the two-dimensional view representation rather than the bird's-eye view representation. (c) in FIG. 28 shows the surrounding image after merging. Here, the display is similar to that of (a) in FIG. 28, i.e., after merging, no following vehicle 22.

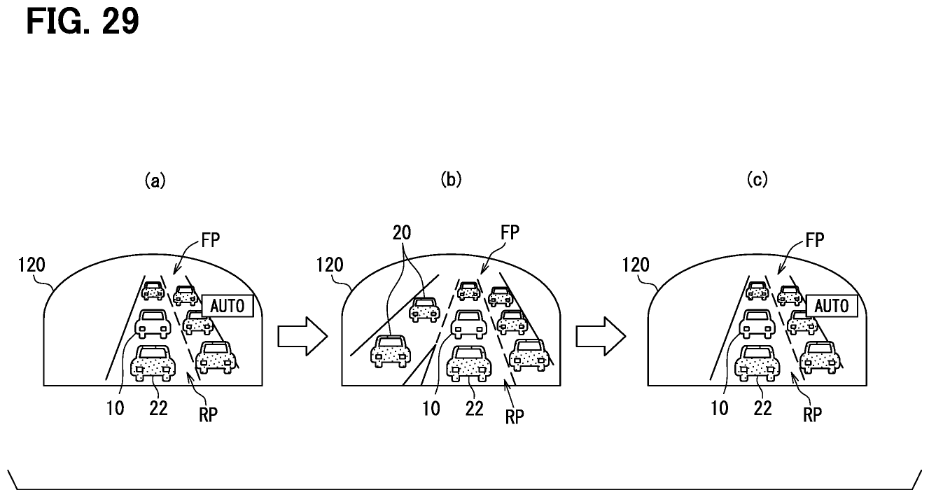

FIG. 29 shows a case where there is a following vehicle 22 due to traffic congestion. (a) in FIG. 29 shows a surrounding image represented by the bird's-eye view at the congestion limited level 3. The position of the subject vehicle 10 may be a center of the surrounding image. (b) in FIG. 29 shows a surrounding image at a merging point. The congestion limited level 3 is changed to the autonomous driving level 2 at the merging point. The other vehicles 20 about to join are displayed in the surrounding image. At this time, the position of the subject vehicle 10 should be slightly moved to the right side so that the other vehicle 20 on the left side, which is on the merging side, can be reliably displayed. Further, the surrounding image may be the two-dimensional view representation rather than the bird's-eye view representation. (c) in FIG. 29 shows the surrounding image after merging. Here, the display is similar to that of (a) in FIG. 29, i.e., after merging, no following vehicle 22.

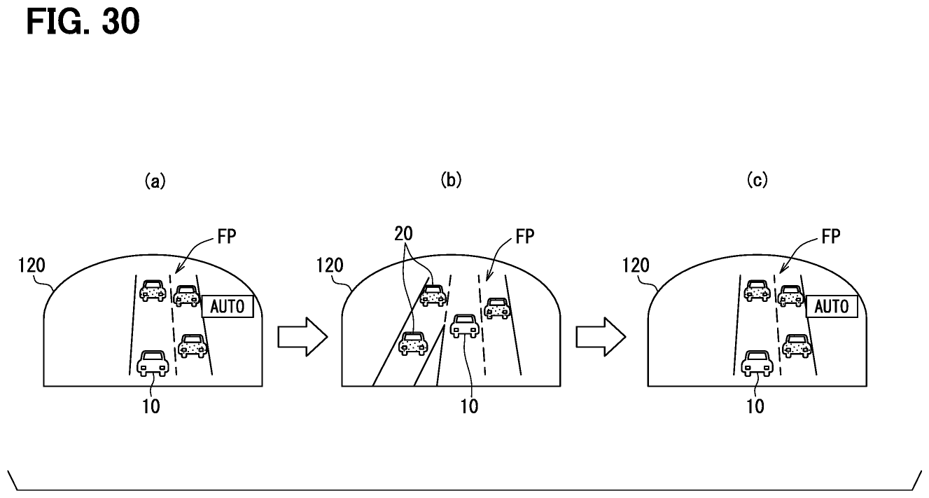

FIG. 30 shows a case where there is no following vehicle 22 in the area limited driving. (a) in FIG. 30 shows a surrounding image that is the two-dimensional representation at the area limited level 3. The position of the subject vehicle 10 may be a bottom of the surrounding image. (b) in FIG. 30 shows a surrounding image at a merging point. The congestion limited level 3 is changed to the autonomous driving level 2 at the merging point. The other vehicles 20 about to join are displayed in the surrounding image. At this time, the position of the subject vehicle 10 should be slightly moved to the right side so that the other vehicle 20 on the left side, which is on the merging side, can be reliably displayed. Also, the surrounding image may be the bird's-eye view representation instead of the two-dimensional view representation. (c) in FIG. 30 shows the surrounding image after merging. Here, the display is similar to that of (a) in FIG. 30, i.e., after merging, no following vehicle 22.

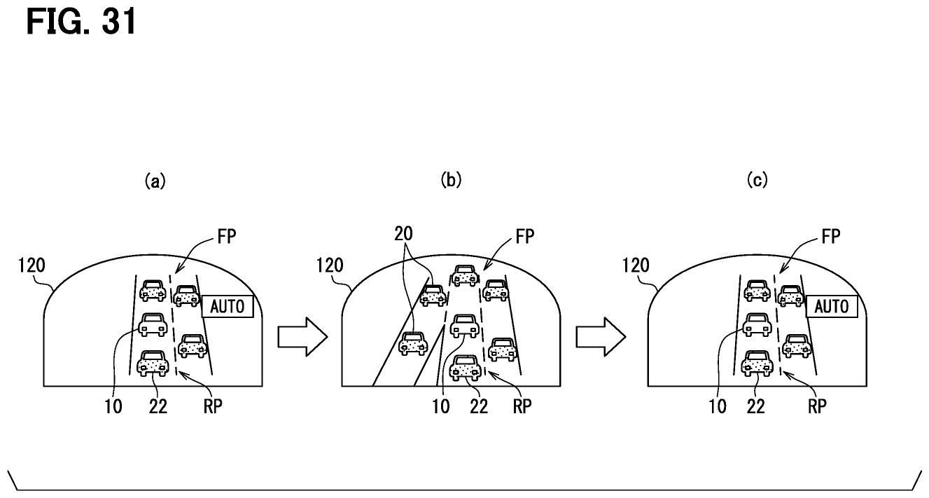

FIG. 31 shows a case where there is a following vehicle 22 in the area limited driving. (a) in FIG. 31 shows a surrounding image that is the two-dimensional view representation at the area limited level 3. The position of the subject vehicle 10 may be a center of the surrounding image. (b) in FIG. 31 shows a surrounding image at a merging point. The area limited level 3 is changed to the autonomous driving level 2 at the merging point. The other vehicles 20 about to join are displayed in the surrounding image. At this time, the position of the subject vehicle 10 should be slightly moved to the right side so that the other vehicle 20 on the left side, which is on the merging side, can be reliably displayed. Also, the surrounding image may be the bird's-eye view representation instead of the two-dimensional view representation. (c) in FIG. 31 shows the surrounding image after merging. Here, the display is similar to that of (a) in FIG. 31, i.e., after merging, with the following vehicle 22.

Accordingly, it is possible to accurately recognize the situation of the other vehicle 20 and the following vehicle 22 (if present) that are about to join at the merging point according to the traveling state of each of the autonomous driving level 3.

### Thirteenth Embodiment

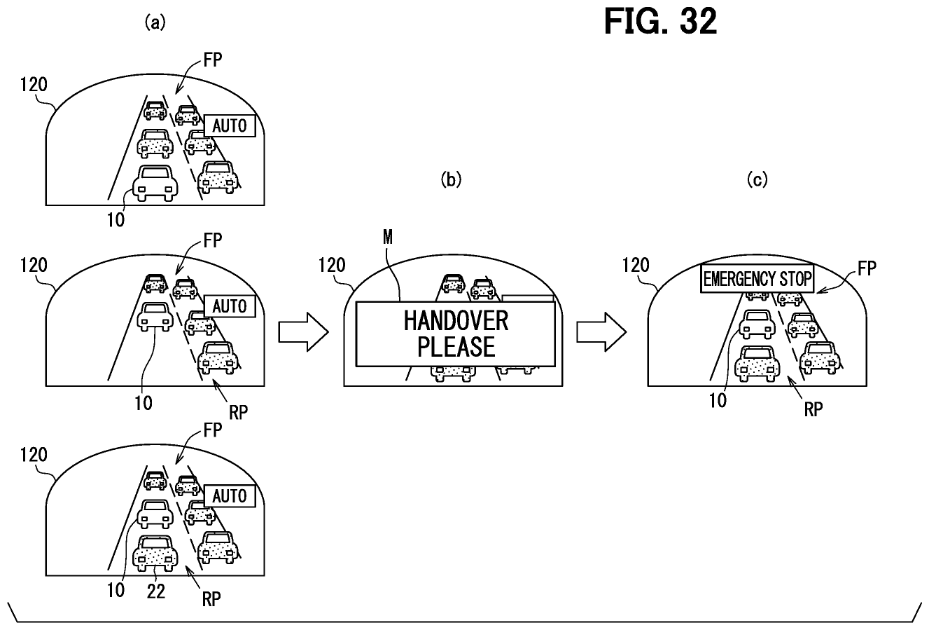

The thirteenth embodiment is shown in FIG. 32. In the thirteenth embodiment, if the driver fails to perform the handover from the autonomous driving to the manual driving, the HCU 160 displays the surrounding vehicles 21 and 22 with the subject vehicle 10 on a center position in the surrounding image until the emergency stop is made as an emergency evacuation.

As shown in (a) in FIG. 32, for example, at the congestion limited level 3, the surrounding image is displayed by the bird's-eye view representation. The upper part of (a) in FIG. 32 shows the case where the subject vehicle 10 does not have the following vehicle 22 and the subject vehicle 10 is displayed in the lower part of the surrounding image. The middle part of (a) in FIG. 32 shows the case where the subject vehicle 10 does not have the following vehicle 22 and the subject vehicle 10 is displayed in the center part of the surrounding image. The lower part of (a) in FIG. 32 shows the case where the subject vehicle 10 has the following vehicle 22 and the subject vehicle 10 is displayed in the center part of the surrounding image.

if it transits from the traffic congestion limited level 3 to the autonomous driving level 2, the HCU 160 displays the message “M” for a handover on the surrounding image as shown in (b) in FIG. 32. The message “M” may be, for example, a content such as “handover please”. Here, if the driver fails a handover to change driving because the driver is looking away or is late in noticing it, the HCU 160 is in an emergency stop (deceleration) as shown in (c) in FIG. 32. At this time, the HCU 160 arranges the position of the subject vehicle 10 in the center of the surrounding image and displays the surrounding vehicles 21 and 22 around it.

As a result, even if the handover fails, it is possible to accurately recognize the situation of the surrounding vehicles 21 and 22 of the subject vehicle 10.

### Fourteenth Embodiment

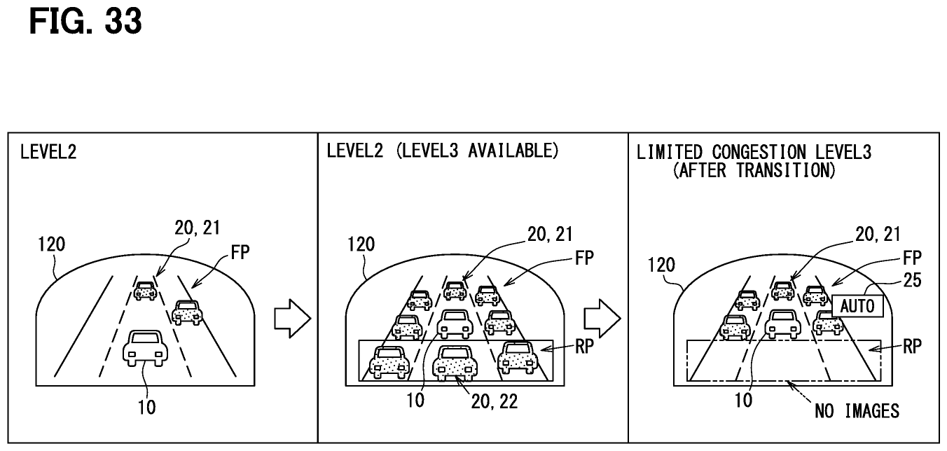

The fourteenth embodiment is shown in FIG. 33. In the fourteenth embodiment, the second autonomous driving ECU 70 performs the autonomous driving control by adding a condition that both a preceding vehicle 21, i.e., a preceding vehicle in front, and a following vehicle 22 exist as a condition for permitting the autonomous driving level 3 or higher.

If it is available to transit from the autonomous driving level 2 or lower, in which the driver's obligation to monitor the surrounding is necessary, to the autonomous driving level 3 or higher, in which the driver's obligation to monitor the surrounding is unnecessary, e.g., the congestion limited level 3, the HCU 160 displays the following vehicle 22 in the surrounding image of the subject vehicle 10, i.e., a middle of FIG. 33. Then, for example, the HCU 160 hides the following vehicle 22 in the surrounding image after the driver performs an input operation to the operation device 150 and it transits to the autonomous driving level 3 or higher (right in FIG. 33).

In order to hide the following vehicle 22 in the surrounding image, the HCU 160 stops outputting an image data of the following vehicle 22 itself acquired by the camera 41 or the like, and not to display on the meter display 120, etc. Alternatively, the HCU 160 changes the camera angle of the camera 41 or the like (acquisition unit) to cut the rear area image RP of the subject vehicle 10 as the display area of the subject image (the subject vehicle 10 is positioned at a lowest position of the surrounding image) to hide the following vehicle 22.

Note that the following vehicle 22 is basically considered to include the following vehicle 22 in a subject vehicle lane (a lane of the subject vehicle 10), but may be considered to include the following vehicle 22 in the subject vehicle lane and the following vehicle 22 in an adjacent lane (a middle of FIG. 33).

In addition, the HCU 160 performs an identification display (a display of AUTO 25) to indicate (identify) that it is the autonomous driving level 3 after transit to the congestion limited level 3.

According to this embodiment, at a stage of the autonomous driving level 3 is available, it is possible to notify the driver that the following vehicle 22 exists as a condition for permitting the autonomous driving in the surrounding image. Then, after transiting to the autonomous driving level 3 or higher, by hiding the following vehicle 22 in the surrounding image, it is possible to reduce an amount of behind information to the driver during the autonomous driving, and to improve a driver's convenience.

### Fifteenth Embodiment

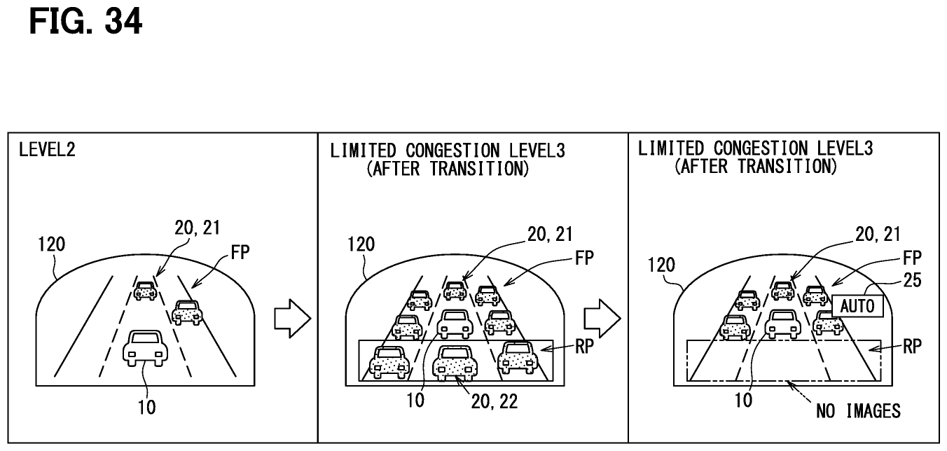

The fifteenth embodiment is shown in FIG. 34. In the fifteenth embodiment, the timing of hiding the following vehicle 22 in the surrounding image is changed from that of the fourteenth embodiment.

That is, if it transits from the autonomous driving level 2 or lower in which the driver's obligation to monitor the surrounding is necessary to the autonomous driving level 3 or higher in which the driver's obligation to monitor the surrounding is unnecessary, e.g., the congestion limited level 3, the HCU 160 displays the following vehicle 22 in the surrounding image of the subject vehicle 10, i.e., a middle of FIG. 34. Then, for example, the HCU 160 hides the following vehicle 22 in the surrounding image after the driver performs an input operation to the operation device 150 and it transits to the autonomous driving level 3 or higher (right in FIG. 34).

According to this, at a stage transiting to the autonomous driving level 3, it is possible to notify the driver that the following vehicle 22 exists as a condition for permitting the autonomous driving in the surrounding image. Then, after transiting to the autonomous driving level 3 or higher, by hiding the following vehicle 22 in the surrounding image, it is possible to reduce an amount of information to the driver during the autonomous driving, and to improve a driver's convenience.

### Sixteenth Embodiment

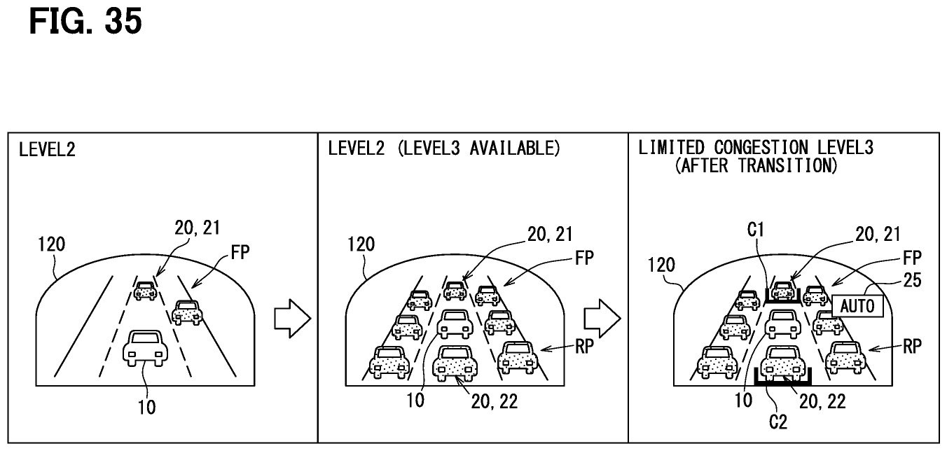

The sixteenth embodiment is shown in FIG. 35. In the sixteenth embodiment, an example is a case in which the automatic following driving to follow the preceding vehicle 21 is performed as the autonomous driving level 3 or higher under condition that the preceding vehicle 21 and the following vehicle 22 are present.

After the transition to the autonomous driving level 3, the HCU 160 displays the first content C1 which emphasizes the preceding vehicle 21 and the second content C2 which emphasizes the following vehicle 22 existing behind the subject vehicle 10 and being detected by the subject vehicle 10 on the surrounding image (right in FIG. 35).

Various mark images are used as the first content C1 and the second content C2. The mark image is, for example, a U-shaped mark as shown in FIG. 35, and may be displayed so as to surround the preceding vehicle 21 and the following vehicle 22 from below. Note that the first and second contents C1 and C2 are not limited to the U-shaped mark, and may be rectangles and circles which surround an entire of the preceding vehicle 21 and the following vehicle 22, dot marks which serve as landmarks, and the like. Also, the first and second contents C1 and C2 may be of similar designs or may be of different designs.

In addition, the HCU 160 may set an emphasis degree by the second content C2 to be lower than an emphasis degree by the first content C1.

Accordingly, by displaying the first and second contents C1 and C2 in the surrounding image, the driver can improve a degree of recognition of the preceding vehicle 21 and the following vehicle 22, which are conditions for the autonomous driving.

Also, by lowering the emphasis degree of the second content C2 with respect to the first content C1, excessive emphasis of the following vehicle 22 on the lower end side of the surrounding image is suppressed, as a result, it is possible to suppress lowering of the degree of recognition of the subject vehicle 10.

### Seventeenth Embodiment

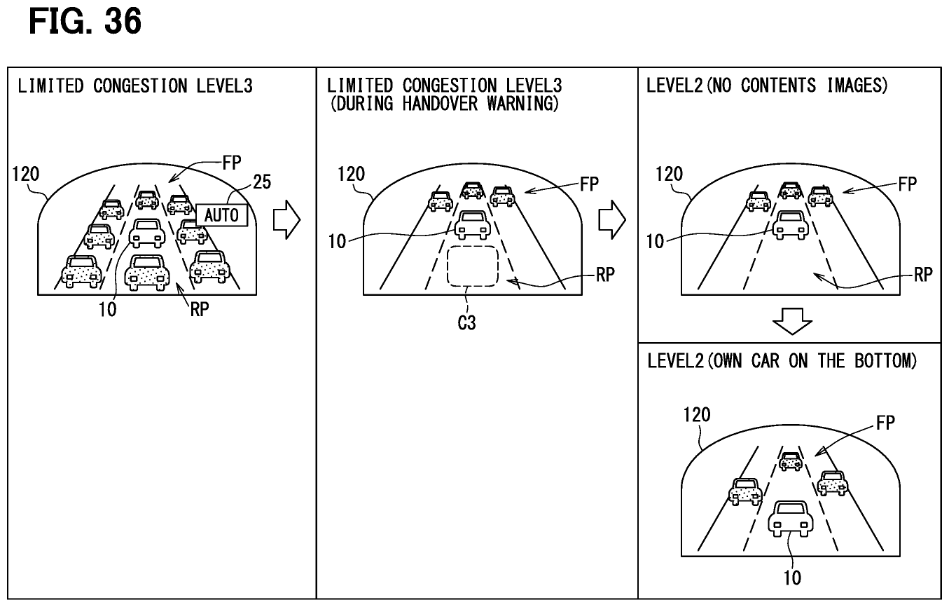

The seventeenth embodiment is shown in FIG. 36. The seventeenth embodiment is an example of the autonomous driving control based on the conditions when there is a preceding vehicle 21 and a following vehicle 22 similar to the fourteenth to sixteenth embodiments.

If it performs a handover from the autonomous driving level 3 or higher, in which the driver's obligation to monitor the surrounding is unnecessary, to the autonomous driving level 2 or lower, in which the driver's obligation to monitor the surrounding is necessary, due to no detection of the following vehicle 22 or absence of the following vehicle 22, the HCU 160 displays the third contents C3 which shows no detection of the following vehicle 22 or absence of the following vehicle 22, i.e., a middle of FIG. 36.

The third content C3 is, for example, a mark image indicating that there is no following vehicle 22, and can be, for example, a square mark. In addition to this, the third content C3 may be a pictogram or the like indicating that there is no following vehicle 22.

Then, the HCU 160 hides the third content C3 if the handover to the autonomous driving level 2 or lower is completed (upper right of FIG. 36).

Furthermore, after hiding the third content C3, the HCU 160 switches to a display form in which the subject vehicle 10 is displayed at the lowest position of the surrounding image (lower right in FIG. 36). The HCU 160 changes the camera angle of the camera 41 and the like to cut the rear area image RP of the subject vehicle 10, and displays the subject vehicle 10 at the lowest position.

As a result, the driver can recognize that the following vehicle 22 has disappeared by displaying the third content C3, and recognize that the autonomous driving level 3 or higher may be canceled.

Then, if the handover to the autonomous driving level 2 or lower is completed, the third content C3 is hidden, so the driver can recognize a surrounding image which is a normal and there is no following vehicle 22. Furthermore, after the third content C3 is hidden, since the subject vehicle 10 is displayed at the lowest position of the surrounding image and unnecessary image information in the rear area disappears, the driver can pay attention to the subject vehicle 10 and the front area.

### Eighteenth Embodiment

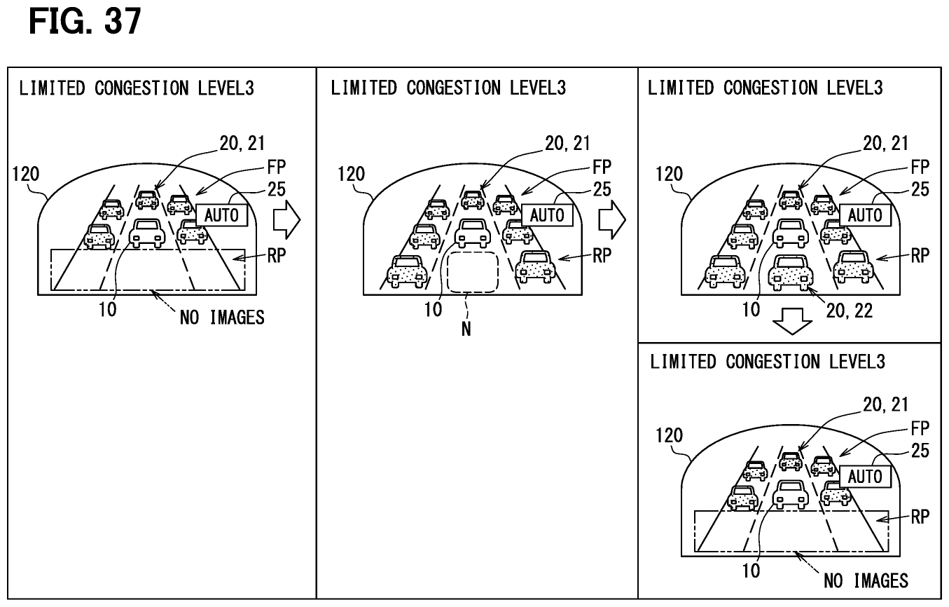

The eighteenth embodiment is shown in FIG. 37. The eighteenth embodiment is an example of the autonomous driving control based on the conditions when there is a preceding vehicle 21 and a following vehicle 22 similar to the fourteenth to seventeenth embodiments.

As described in the fourteenth embodiment, the HCU 160 hides the following vehicle 22 (left in FIG. 37) in response to a transit to the autonomous driving level 3 or higher, i.e., the congestion limited level 3. Then, after that, if the following vehicle 22 becomes being not detected, the HCU 160 displays a notification mark “N”, which indicates (notifies) that the following vehicle 22 is not detected temporarily, behind the subject vehicle 10 in the surrounding image. (middle of FIG. 37).

The notification mark “N” is, for example, a mark image indicating that there is no following vehicle 22, and can be, for example, a square mark. In addition to this, the notification mark “N” may be a pictogram or the like indicating that there is no following vehicle 22.

In addition, if the following vehicle 22 is detected again, the HCU 160 displays the following vehicle 22 in the surrounding image (upper right in FIG. 37), and then hides the display of the following vehicle 22 (lower right of FIG. 37).

In order to hide the following vehicle 22 in the surrounding image, the HCU 160 stops outputting an image data of the following vehicle 22 itself acquired by the camera 41 or the like as described in the above embodiment, and displays the data on the meter display 120, etc. (bottom right of FIG. 37).

Furthermore, the HCU 160 changes a bird's-eye view angle of the acquisition unit with respect to the following vehicle 22 when hiding the following vehicle 22. That is, as described in the above embodiment, the HCU 160 changes the camera angle of the camera 41 (acquisition unit) or the like to cut the rear area image RP of the subject vehicle 10 as the display area of the surrounding image, and displays the subject vehicle 10 at the lowest position (corresponding to the lower right of FIG. 36).

As a result, if the following vehicle 22, which is present but is hidden, becomes undetected (does not exist), since the notification mark “N” is displayed, the driver can recognize that the following vehicle 22 has disappeared by this notification mark “N” in the autonomous driving level 3 or higher.

After that, if the following vehicle 22 is detected again, the following vehicle 22 is displayed in the surrounding image, so that the driver can recognize a substantial situation of behind. Further, after that, since the following vehicle 22 is hidden in the surrounding image, it is possible to reduce an amount of information behind during the autonomous driving for the driver, and to improve a driver's convenience.

### Nineteenth Embodiment

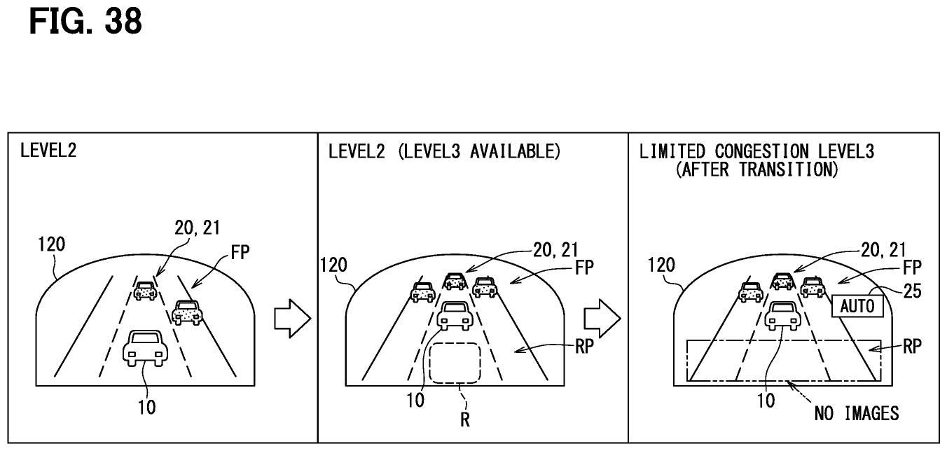

The nineteenth embodiment is shown in FIG. 38. The nineteenth embodiment is an example of the autonomous driving control based on the conditions when there is a preceding vehicle 21 and a following vehicle 22 similar to the fourteenth to eighteenth embodiments.

The HCU 160 considers that if the preceding vehicle 21 already exists and the following vehicle 22 exists, then determines that it is a situation in which it is possible to transit to the autonomous driving level 3 or higher, i.e., it is a pre-transition possible state to the autonomous driving, and displays a pre-transition image “R” at a position corresponding to the following vehicle 22 in the surrounding image (a center of FIG. 38).

The pre-transition image “R” may be, for example, a square mark. In addition to this, the pre-transition image “R” may be a pictogram or the like indicating a pre-transition possible state.

Note that the pre-transition image “R” is displayed when one more condition is met and a transition to the autonomous driving is possible, which corresponds to a “reach” state referred to in games and the like, and the pre-transition image “R” may also be called as a reach image.

Note that the following vehicle 22 is hidden (right in FIG. 38) similar to the fourteenth embodiment after it transits to the autonomous driving level 3 or higher while the following vehicle 22 is present.

Accordingly, the driver can easily recognize from the pre-transition image “R” whether the possibility of transition to the autonomous driving is high or low.

### Other Embodiments

Further, although, in each of the above-described embodiments, the display unit is the meter display 120, the display unit is not limited to this, and another HUD 110 or CID 130 may be used as the display unit. When the CID 130 is used as the display unit, the CID 130 can implement a display related to the autonomous driving and an operation (touch operation) for switching to the autonomous driving.

Further, the CID 130 may be formed of, for example, multiple CIDs, and may be a pillar-to-pillar type display unit in which the meter display 120 and the multiple CIDs are arranged in a horizontal row on the instrument panel.

The disclosure in this specification, the drawings, and the like is not limited to the exemplified embodiments. The disclosure encompasses the illustrated embodiments and variations based on the embodiments by those skilled in the art. For example, the present disclosure is not limited to the combinations of components and/or elements shown in the embodiments. The present disclosure may be implemented in various combinations. The present disclosure may have additional members which may be added to the embodiments. The present disclosure encompasses the embodiments where some components and/or elements are omitted. The present disclosure encompasses replacement or combination of components and/or elements between one embodiment and another. The disclosed technical scope is not limited to the description of the embodiment. It should be understood that some disclosed technical ranges are indicated by description of claims, and includes every modification within the equivalent meaning and the scope of description of claims.

The controller and the techniques thereof according to the present disclosure may be implemented by one or more special-purposed computers. Such a special-purposed computer may be provided by configuring a processor and a memory programmed to execute one or more functions embodied by a computer program.

Alternatively, each control unit and the like, and each method thereof described in the present disclosure may be implemented by a dedicated computer provided by including a processor with one or more dedicated hardware logic circuits.

Alternatively, the control unit and the like and the method thereof described in the present disclosure may be achieved by one or more dedicated computers constituted by a combination of a processor and a memory programmed to execute one or a plurality of functions and a processor constituted by one or more hardware logic circuits.

The computer program may be stored in a computer-readable non-transitory tangible storage medium, as an instruction to be executable by a computer.

What is claimed is:

1. A vehicle display apparatus, comprising:
a display unit which displays traveling information of a vehicle;
an acquisition unit which acquires position information of the vehicle and surrounding information of the vehicle; and
a display control unit which, based on the position information and the surrounding information, displays a front area image including the vehicle on the display unit when an autonomous driving function of the vehicle is not demonstrated, and
displays the front area image and a rear area image including a following vehicle in a continuous and additional manner when the autonomous driving function is demonstrated.

2. The vehicle display apparatus according to claim 1, wherein
the display control unit widens a rear area as a distance between the vehicle and the following vehicle increases.

3. The vehicle display apparatus according to claim 2, wherein
if the distance is equal to or greater than a predetermined distance, the display control unit maximizes the rear area and displays the following vehicle as a simple display for indicating an existence.

4. The vehicle display apparatus according to claim 1, wherein
if a distance between the vehicle and the following vehicle varies, the display control unit fixes a rear area to an area capable of absorbing a variation in the distance.

5. The vehicle display apparatus according to claim 1, wherein
if there is a priority following vehicle having a predetermined high priority in the following vehicle, the display control unit displays up to the priority following vehicle in a rear area.

6. The vehicle display apparatus according to claim 5, wherein
the display control unit performs an emphasized display which emphasizes the priority following vehicle.

7. The vehicle display apparatus according to claim 1, wherein
the display control unit performs a unity image display showing a sense of unity of the vehicle and the following vehicle in a case that the following vehicle performs an automatic following driving to the vehicle.

8. The vehicle display apparatus according to claim 1, wherein
the display control unit displays a message indicating a relationship between the vehicle and the following vehicle.

9. The vehicle display apparatus according to claim 8, wherein
the display control unit, in displaying the message, displays so as not to overlap the vehicle and the following vehicle among the image.

10. A vehicle display apparatus, comprising:
a display unit which displays traveling information of a vehicle;
an acquisition unit which acquires position information, traveling state, and surrounding information of the vehicle; and
a display control unit which displays a surrounding image of the vehicle on the display unit as one of the traveling information, and
switches a display form relating to a relationship among the vehicle and a surrounding vehicle in the surrounding image according to:
a level of autonomous driving of the vehicle set based on the position information, the traveling state, and the surrounding information;
the traveling state; and
a state of surrounding vehicles as the surrounding information, wherein
the display control unit displays a front area image including the vehicle when it is an autonomous driving level 1 or an autonomous driving level 2, in which a driver's obligation to monitor a surrounding is necessary, and
displays the front area image and a rear area image of a following vehicle in an additional manner when it is an autonomous driving level 3 or higher, in which the driver's obligation to monitor the surrounding is unnecessary.

11. The vehicle display apparatus according to claim 10, wherein
when it is the autonomous driving level 3 or higher in a traffic congestion, the display control unit displays, if there is a following vehicle, the rear area image up to a rear end of the following vehicle, and
displays, if there is no following vehicle, a wider area than an area assuming the following vehicle.

12. The vehicle display apparatus according to claim 10, wherein
if it is the autonomous driving level 3 or higher in an area limited autonomous driving which is the autonomous driving is permitted in a predetermined specific area, the display control unit displays the surrounding image by a two-dimensional view representation in which the vehicle is captured from above and the vehicle is placed in a center.

13. The vehicle display apparatus according to claim 10, wherein
if a dangerous vehicle, which may be dangerous to the vehicle, approaches, the display control unit displays the dangerous vehicle so as to be included in the rear area image.

14. A vehicle display apparatus, comprising:
a display unit which displays traveling information of a vehicle;
an acquisition unit which acquires position information, traveling state, and surrounding information of the vehicle; and
a display control unit which displays a surrounding image of the vehicle on the display unit as one of the traveling information, and
switches a display form relating to a relationship among the vehicle and a surrounding vehicle in the surrounding image according to:
a level of autonomous driving of the vehicle set based on the position information, the traveling state, and the surrounding information;
the traveling state; and
a state of surrounding vehicles as the surrounding information, wherein
the display control unit enables, as the display form, a bird's-eye view representation captured from a rear above of the vehicle and a two-dimensional view representation captured from above the vehicle, and
uses the two-dimensional view representation if a display area is widened more than that of the bird's-eye view representation, wherein
the display control unit uses the bird's-eye view representation when an autonomous driving level 3 in a traffic congestion is performed as a level of the autonomous driving, in which a driver's obligation to monitor a surrounding is unnecessary;
uses the two-dimensional view representation when an autonomous driving level 3 in an area limited in which the autonomous driving is permitted in a predetermined area; and
switches from the bird's-eye view representation to the two-dimensional view representation, or from the two-dimensional view representation to the bird's-eye view representation according to a situation of the surrounding vehicle.

15. A vehicle display apparatus, comprising:
a display unit which displays traveling information of a vehicle;
an acquisition unit which acquires position information, traveling state, and surrounding information of the vehicle; and
a display control unit which displays a surrounding image of the vehicle on the display unit as one of the traveling information, and
switches a display form relating to a relationship among the vehicle and a surrounding vehicle in the surrounding image according to:
a level of autonomous driving of the vehicle set based on the position information, the traveling state, and the surrounding information;
the traveling state; and
a state of surrounding vehicles as the surrounding information, wherein
the display control unit enables, as the display form, a bird's-eye view representation captured from a rear above of the vehicle and a two-dimensional view representation captured from above the vehicle, and
uses the two-dimensional view representation if a display area is widened more than that of the bird's-eye view representation, wherein
the display control unit increases a frequency of use of the bird's-eye view representation out of the bird's-eye view representation and the two-dimensional view representation as a vehicle speed of the vehicle and the following vehicle increases.

16. A vehicle display apparatus, comprising:
a display unit which displays traveling information of a vehicle;
an acquisition unit which acquires position information, traveling state, and surrounding information of the vehicle; and
a display control unit which displays a surrounding image of the vehicle on the display unit as one of the traveling information, and
switches a display form relating to a relationship among the vehicle and a surrounding vehicle in the surrounding image according to:
a level of autonomous driving of the vehicle set based on the position information, the traveling state, and the surrounding information;
the traveling state; and
a state of surrounding vehicles as the surrounding information, wherein
the display control unit displays the surrounding image in accordance with an autonomous driving level 3 in a traffic congestion in which a driver's obligation to monitor a surrounding is unnecessary,
continues the display of the surrounding image of the autonomous driving level 3 even if it transits to an autonomous driving level 2 or lower in the traffic congestion, in which the driver's obligation to monitor the surrounding is necessary, and the traffic congestion is not resolved, and
displays the surrounding image according to an autonomous driving level 2 or lower it transits to the autonomous driving level 2 or lower due to resolving the traffic congestion.

17. The vehicle display apparatus according to claim 16, wherein
the display control unit performs an identification display indicating that an autonomous driving level 3 is being executed when it is the autonomous driving level 3.

18. A vehicle display apparatus, comprising:
a display unit which displays traveling information of a vehicle;
an acquisition unit which acquires position information, traveling state, and surrounding information of the vehicle; and
a display control unit which displays a surrounding image of the vehicle on the display unit as one of the traveling information, and
switches a display form relating to a relationship among the vehicle and a surrounding vehicle in the surrounding image according to:
a level of autonomous driving of the vehicle set based on the position information, the traveling state, and the surrounding information;
the traveling state; and
a state of surrounding vehicles as the surrounding information, wherein
if a level of autonomous driving transits to an autonomous driving level 3, in which a driver's obligation to monitor a surrounding is unnecessary, and a driver begins a second task which is permitted as an action other than driving to the driver, the display control unit switches from the surrounding image to a predetermined minimum display content, and switches from the predetermined minimum display content to the surrounding image if the driver interrupts the second task, if there is an approaching other vehicle or there is a fast-moving other vehicle.

19. A vehicle display apparatus, comprising:
a display unit which displays traveling information of a vehicle;
an acquisition unit which acquires position information, traveling state, and surrounding information of the vehicle; and
a display control unit which displays a surrounding image of the vehicle on the display unit as one of the traveling information, and
switches a display form relating to a relationship among the vehicle and a surrounding vehicle in the surrounding image according to:
a level of autonomous driving of the vehicle set based on the position information, the traveling state, and the surrounding information;
the traveling state; and
a state of surrounding vehicles as the surrounding information, wherein
the display control unit switches the display form to a bird's-eye view representation captured from a rear above of the vehicle if a lane next to the vehicle is congested, and
when the lane next to the vehicle is not congested, switches to a two-dimensional view representation captured from above the vehicle if a lane next to the vehicle is not congested.
